(19) United States
(12) Patent Application Publication
(10) Pub. No.: US 2005/0120196 A1
(43) Pub. Date: Jun. 2, 2005

(54) System for maintaining telecommunications networks

(76) Inventor: Robert Zito, Staten Island, NY (US)

Correspondence Address: GOLDMAN IP LAW;JOEL S. GOLDMAN, 200 GALLERIA PARKWAY, SUITE 1820, ATLANTA, GA, 30339, US

(21) Appl. No.: 10/611,028

(22) Filed: Jul. 1, 2003

Related U.S. Application Data
(60) Provisional application No. 60/393,714, filed on Jul. 2, 2002.

(51) Int. Cl. G06F 1/24

(52) U.S. Cl. 713/100

(57) ABSTRACT

A system is disclosed for controlling the field repair of electronic networks containing geographically-dispersed network components. The system includes a memory in a central computer system which stores data regarding the service history and physical location of each network component. This central computer also includes means for generating a machine-readable record for a service technician, which includes records for each possible service action. A portable computer device for the technician contains means for reading at least one of these records.

### PRIORITY CLAIM

Applicant claims priority based on Provisional Application Ser. No. 60/393,714 filed Jul. 2, 2002.

### BACKGROUND OF THE INVENTION

Historically, the cable telecommunication industry has always lacked the ability to efficiently track power supply maintenance. The system(s) that have historically tracked power supply maintenance have either kept all logs in a book, or given paperwork to administrative personnel to input into the database or flat spreadsheets. Coupled with this problem, there is a need to ensure that cable systems would not suffer major outages because of blackouts of electric power. Thus, there is a need to visit all power supplies in the system, and document all parameters for these power supplies on a regular basis.

Maintenance of telecommunications systems and, in particular, cable television systems, presents several problems. Firstly, periodic maintenance of the power supplies which are part of the system must be performed in order to minimize system downtime resulting from loss of power. Presently, maintenance of power supplies is performed by technicians in the field who record results of the testing of these power supplies on paper. This paper is brought back to a central office, and all of the data is then entered into a computer system for analysis.

In a cable system, for every mile of physical plant, there are approximately two (2) power supplies. Thus, in a typical cable system having three thousand (3,000) miles of plant, or cable wiring, there are approximately six thousand (6,000) power supplies that must be maintained.

If power supply maintenance is not performed properly, the power supplies may not go into a proper standby mode when utility power is interrupted. Thus, it is critical to replace battery backups in the power supplies on a regular basis, and to keep records of how long these batteries have been in a particular power supply because the batteries have a limited useable life. The batteries also have a limited shelf life (approximately three (3) months); therefore, if more batteries are ordered than necessary to replace batteries in the field, the batteries not used will eventually go dead on the shelf. There is a need, therefore, for a system which can track maintenance of power supplies and their backup batteries, and schedule replacement of these batteries when, and only when, such replacement is needed.

Another field maintenance function which must be performed on cable television systems relates to the cumulative leakage index (“CLI”). Cable television systems are regulated by the Federal Communications Commission (“FCC”), which monitors frequencies within the aeronautical band. A loose fitting, or other defect, in a cable television system may emit radio frequencies in the aeronautical band, which may disrupt communications between a tower and a commercial airliner. The FCC uses trucks and other vehicles (e.g., helicopters) to monitor radio frequency leakage in these bands within a given area. It is up to the cable television system operator to localize these leaks, repair them, and make appropriate report(s) to the FCC as to these repairs. CLI maintenance is done by cable television systems on a quarterly basis, and reports must be submitted to the FCC a month after the previous quarter.

During a quarter, the average cable television system may have one (1) radio frequency leak per mile of system. In order to repair these leaks, a cable television technician, typically, will go out in a truck with a GPS recorder and a CLI measuring device (which is commonly known as a “CLI gun”). Every time a leak is detected, the technician records the magnitude of the leak, and the latitude and the longitude. This information is recorded on a magnetic disk. The disk is then brought back to a central office, edited, and imported into a CLI management database. The system then prints out work orders that are routed to technicians, who go out, make repairs, and submit proper reports to the central office. Due to the thousands of radio frequency leaks which typically occur in a typical cable television system during a quarter, the method presently used for maintaining records of repair(s) of these leaks is cumbersome and fairly unmanageable.

In accordance with the present invention, a database has been created where all notes and power supplies of a cable system will be documented. Once the data has been inputted into the database, the user has the option of creating labels for all of the equipment in a bar-coded format. These labels may be printed, for example, on standard 8½×11″ paper from any laser or ink jet printer and then folded, laminated, and hung on each piece of equipment, such as a power supply, in the cable system. Each label has a “Loc Bar Number”—a unique bar code number telling the database the location and type of power supply or node.

Also in accordance with the present invention, software for an off-the-shelf portable data terminal (“PDT”) has been written. Such a PDT is a simple and rugged bar code reader, ideal, for field use. The technician leaves the shop with the device, and begins his maintenance for the day. The technician opens the power supply, enters PSM mode on the hand-held device, and the unit starts asking the technician for information, walking him through a series of questions regarding the power supply. Some of these questions may relate to visual checks (e.g., visual check Battery 1, visual check battery shelf, etc.). In order to respond to these queries, the technician may merely scan in the bar codes for “good,” “fair,” or “poor,” which are printed on the label. At present, the PDTs are capable of storing data relating to over two hundred (200) visits to power supplies. The technician may download the information from his PDT daily, either by connecting to the network at a central location, or by downloading by radio frequency, or other means.

For example, for downloading at a central location, the technician may drop the PDT into a suitable cradle, open particular software for reading the data, select the data retrieval mode, and start downloading his data into the program running at the central location. The download time would be minimal, in most cases less than thirty (3) seconds. Once the session between the PDT and the program is completed, the technician can start viewing the entries.

The information can be edited if necessary. The information edited can be validated, and the database updated, with the information. When the updates are complete, various reports can be generated.

Some of these reports may include:
a. Detailed Visits—detailed information of what was captured at each power supply;
b. Battery Replacement—an indication as to when and where batteries in the system need to be replaced. The criteria for battery replacement may be set by the user, (e.g., every forty-eight (48) months);
C. Battery Replacement Budgetary—an indication to the user as to has much to budget each year for batteries. The user may set the criteria for a dollar amount, and the month in which the dollar(s) should be appropriated; and
d. Response Time—an indication as to how long each technician is spending at each power supply, and travel time between visits.

Another feature of the system is that the user may set up reporting criteria for a number of days between visits to a particular piece of equipment (e.g., power supplies, battery costs, number of months per manufacture date at which batteries must be replaced, and cost(s) per kilowatt hour).

### SUMMARY OF THE INVENTION

The present invention solves the above and other problems associated with cable television system maintenance in an efficient and cost-effective manner. The system has a number of novel features which are not currently available in current systems for maintaining cable television systems. Among these features are:
a. Use of a unique bar code to identify each unit in the field with respect to its characteristics and location;
b. Use of a portable computer, or a PDA capable of reading bar codes, to assist the technician in servicing components of a cable television system in the field;
c. Use of a card, or “cheat sheet,” encoded with useful information tailored to a particular event to give the technician a rapid and convenient way for entering information into his PDA in the field, even when the technician is wearing heavy gloves (such as may be necessary when servicing electrical equipment);
d. Providing a software system, which keeps track of power utility providers for each power supply in the field which makes the information readily accessible to field technicians;
e. Providing a software system, which automatically keeps track of the start and finish time for maintenance service by the technician on a particular piece of equipment in the field;
f. Providing a software system, which keeps track of warranty information and expiration dates on each piece of equipment in the field and is available to field technicians when they perform service on each particular device;
g. Providing a software system, accessible by the field technicians which records actions taken by the technician to repair each radio frequency leak;
h. Utilization of industry standard GPS technology for the use of gathering CLI information for import into a program for managing RF leak detection along with the ability to manually record CLI leakage information for bar-coded work orders as well as bar-coded fix code sheets for scanning results for latter download and automated analysis;
i. Providing a means to record equipment calibration and staff member evaluation dates for scheduling with local PIM software (i.e., Microsoft Outlook), and generate automated reminders for users;
j. Utilization of a hand-held bar code terminal of field data recording for routine maintenance practices;
k. Downloading of data to software at a central office for analysis;
l. Elimination of the need for administrative input for recorded test results;
m. Providing a means to record the time and date of each visit of a technician to each piece of equipment, creating an accurate timetable of productive work;
n. Providing a means to allow the cable system operator to generate budgetary reports on costly battery replacement along with appropriated expenditures;
o. Utilization of bar-coded labels for data entry, along with PIM software for routine maintenance purposes;
p. Utilization of bar-coded answer sheets for quick and accurate reporting; and
q. Elimination of the need for paper records.

### DETAILED DESCRIPTION OF THE INVENTION

In a currently preferred embodiment, the software for implementing the cable television system maintenance of the current invention is written in Microsoft Access. A portion of it resides in a desktop computer at the central office of the cable system operator, from which maintenance personnel are dispatched. Other portions of the software system are contained in hand-held computers, or personal digital assistants (“PDA”), which are taken by the technician to the field.

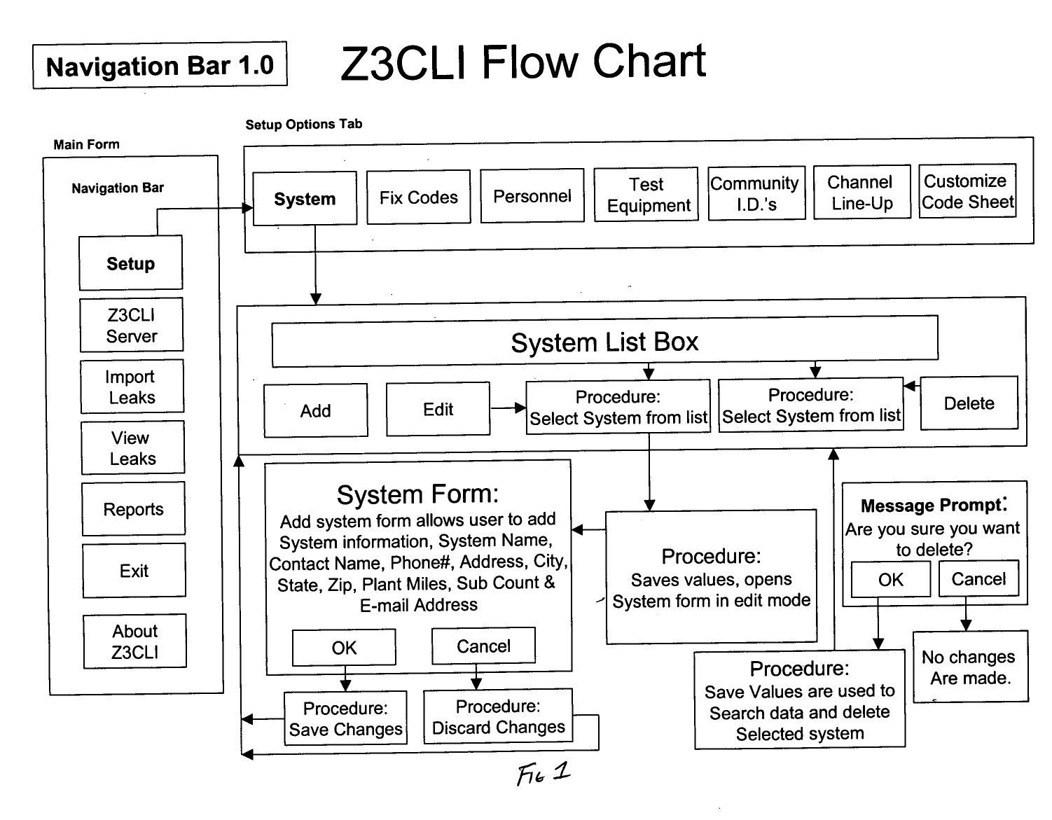

Referring to FIG. 1, there is shown the initial display of the desktop portion of the software system. This display is used to set up the system and various initial procedures discussed in greater detail below.

At the left hand side of FIG. 1 is a “Navigation Bar,” which gives the user the option to set up the server, import leaks, view leaks, and produce reports. By clicking the “setup” button, a “setup options” tab display is generated, which allows the user to set up the system, fix codes, assign personnel, assign test equipment, enter community identifications, enter the channel lineup, and customize the code sheet (“cheat sheet”), which contains bar code(s) representative of various types of data which the field technician may need to enter into his hand-held computer.

Clicking the “system” button in the “setup options” tab allows the user to configure the system. The user may enter, or delete, information regarding the system name, the system telephone number, contact names, e-mail addresses, subscribers to the system, and all other logistical information about the system.

Clicking the “fix codes” button assigns codes to each type of “fix,” or repair, which may be accomplished by a field technician. For example, “fix 1” may be a loose fitting, “fix 2” may be a loose fitting on top, “fix 3” may be a broken port. All of the fix codes are printed out on a bar code sheet. Thus, a bar-coded work order is printed with various fix codes, which the field technician can scan in the field to enter the type of fix that he performed to fix a particular problem.

Clicking the “personnel” button allows entry of data regarding all technicians currently performing maintenance functions, including CLI. Such a list is required by the FCC, which also requires information to be entered regarding the credentials of each technician and how long the technician has been employed.

Clicking the “test equipment” button allows entry of data regarding test equipment, which is also required by the FCC. This information may include, for example, the make, model, serial number, and last calibration date for a particular piece of test equipment. Additional data may also be entered regarding the calibration cycle for the test equipment, such as every year, every two (2) years, and so forth. When a particular piece of equipment is calibrated, the information will be entered in the system, and the system will produce a reminder that calibration is due on that piece of equipment at the appropriate time based on the calibration cycle which has been entered.

Clicking the “community I.D.” button allows information to be entered regarding “community I.D.s”, which is required by the FCC. Each system head-end has a unique I.D. number, and each community has a number which is unique to a head-end I.D. Reports provided to the FCC requires data which identifies the head-end which feeds the particular point in the system at which the maintenance was performed. A head-end system I.D. is unique to the system, and the community I.D.s are also unique to the head end site.

Clicking the “channel lineup” button allows information to be entered regarding all frequencies being broadcast in the aeronautical band, the identity of the programmer using that frequency, etc.

Clicking the “customized code sheet” button allows the user to enter auxiliary fields in the code sheet that are printed out in bar code format.

FIG. 1 also shows the sequence of events which will occur when the operator of the system clicks the “system” button in the “setup options” tab. The clicking of this button leads the user to several “procedures,” or scripted events, which as illustrated by FIG. 1, allow the user to add or delete particular cable system(s) from the database, or edit information regarding those system(s). Addition of a system, for example, initiates a procedure in which the user completes the information in a “system form,” which may include system name, contact name, phone number, address, city, state, zip code, plant miles, subscribers, and e-mail address.

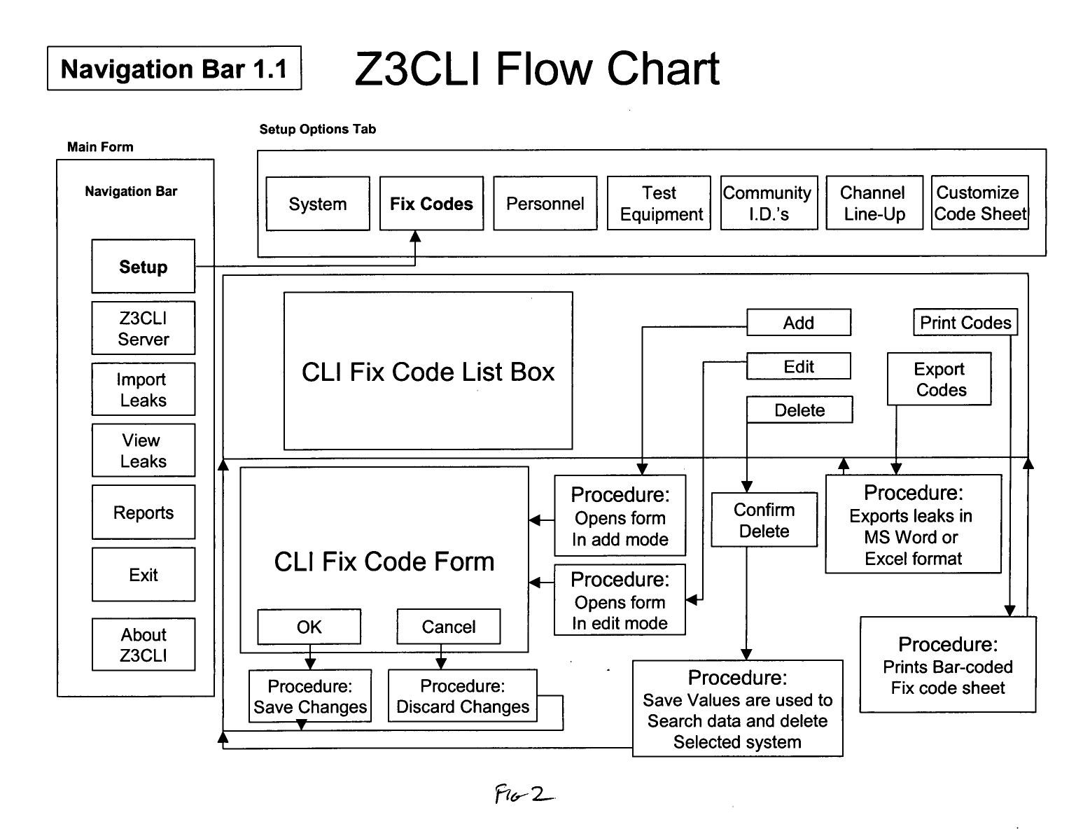

Referring to FIG. 2, clicking of the “fix codes” button initiates a procedure whereby the user can set up fix codes by completing information in a fix code form. These procedures allow the user to add a fix code, edit a fix code, delete a fix code, export a fix code into a Microsoft Excel work format, or print the fix code. Printing the codes causes the fix code(s) to be printed in a bar-coded format, on a sheet which the technicians may take with then when performing field service.

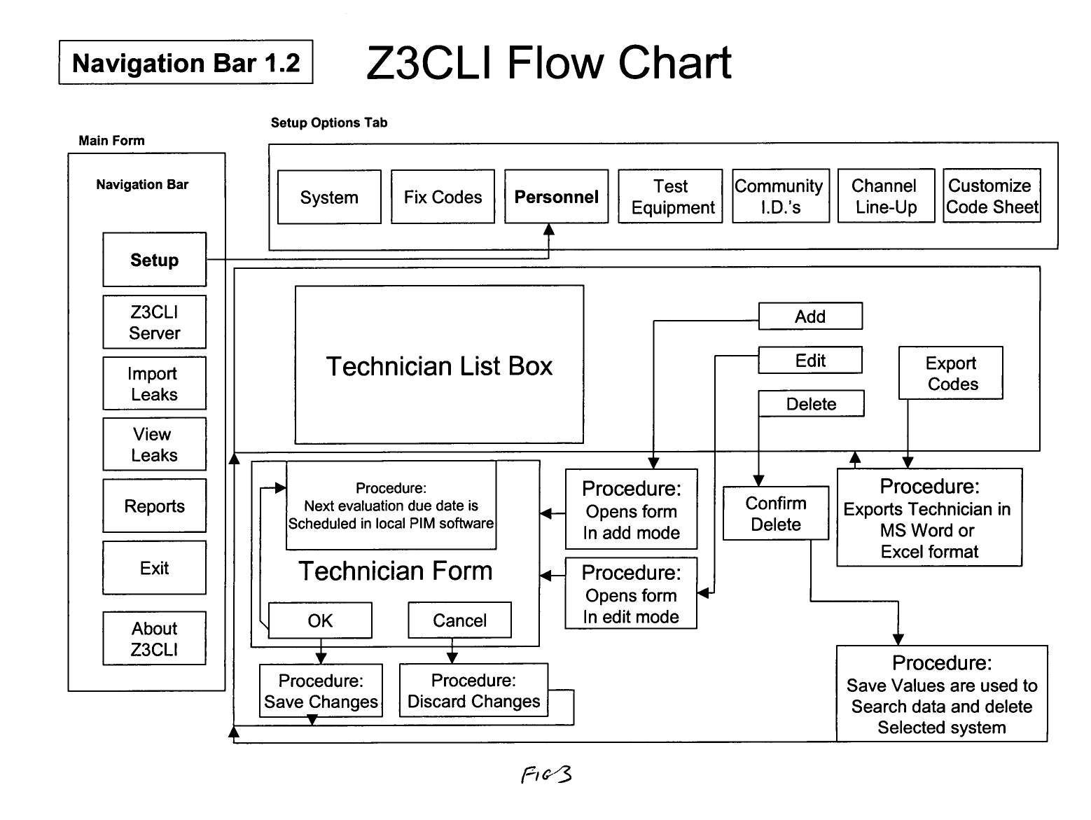

FIG. 3 shows the procedure that the system operator can use regarding personnel. By following this procedure, the operator can add, edit, delete, or “export” the technician's identifying data into either a Microsoft Word format or a Microsoft Excel format. The exported data may include name, credentials, how long the technician has been employed, and when their next evaluation date is coming up.

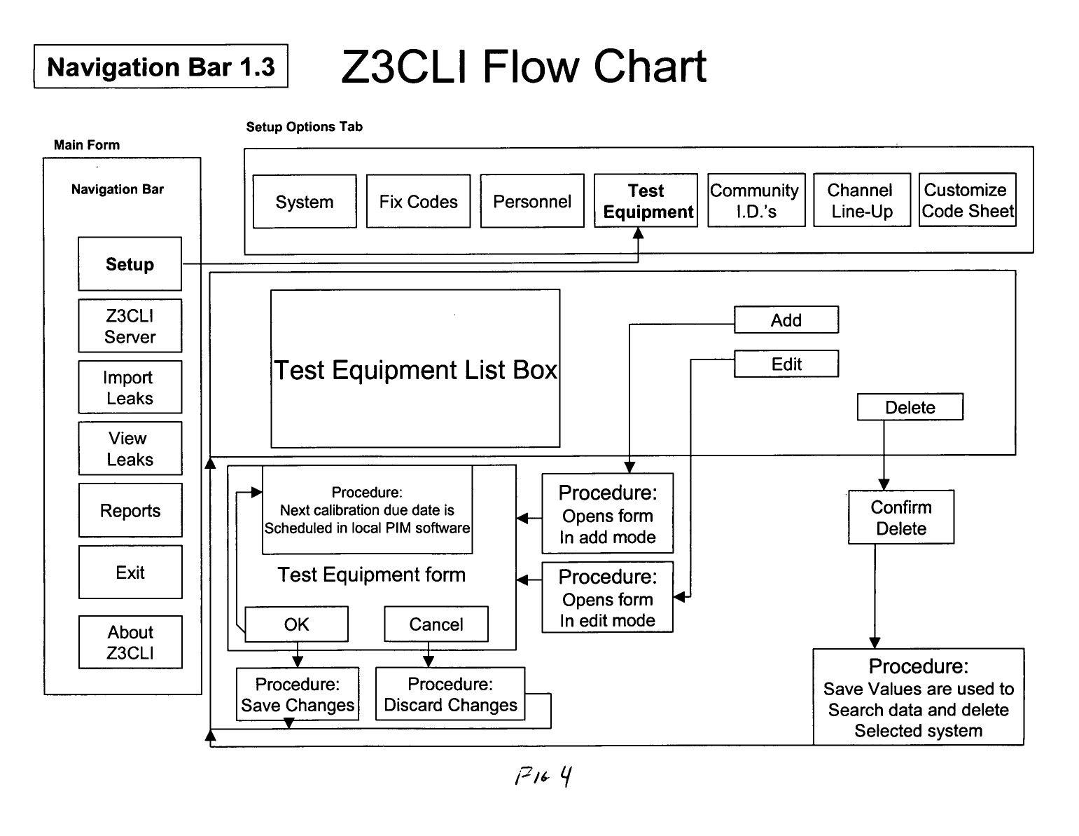

FIG. 4 allows the operator of the system to add, edit, or delete information regarding test equipment from the system. For example, to add equipment information to the system, the add button is clicked, and a procedure will run that will automatically book the next calibration date of the equipment into the software.

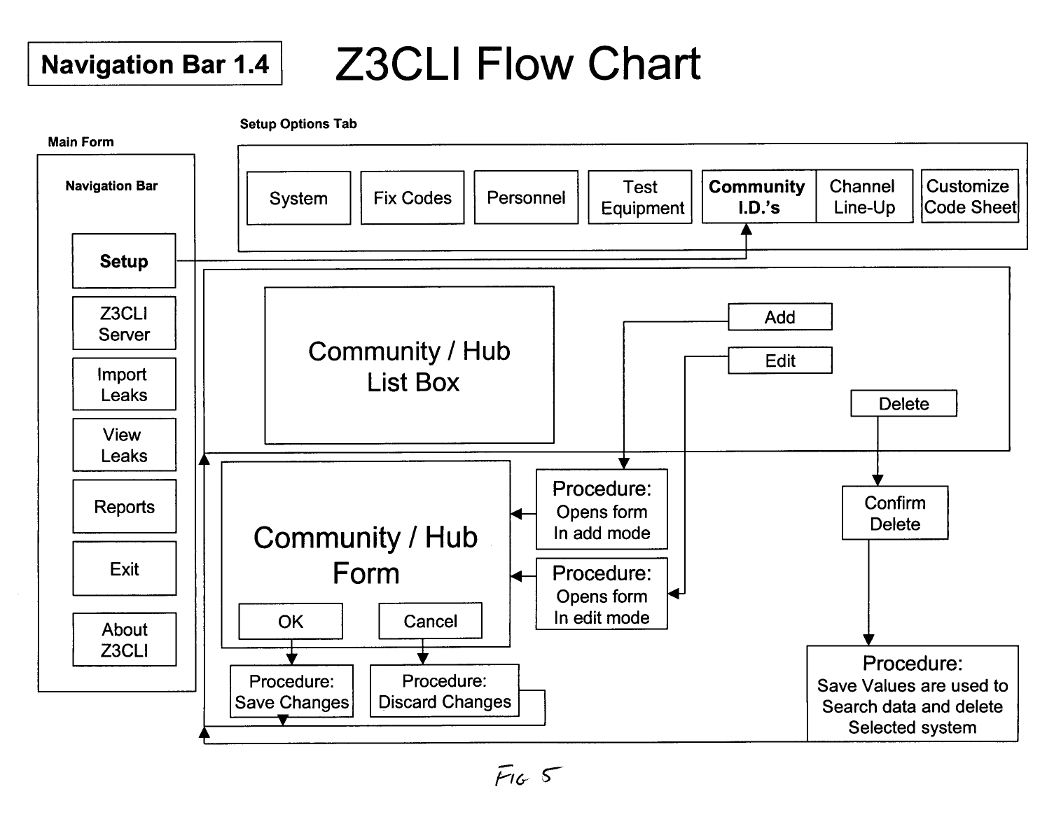

Referring to FIG. 5, the user of the system is allowed to add, edit, or delete any of the community I.D. information which may be required. This information may include the name of the town, the franchise of the town, and information regarding the hub or system operator. This can accommodate a situation in which several head-ends are feeding different towns.

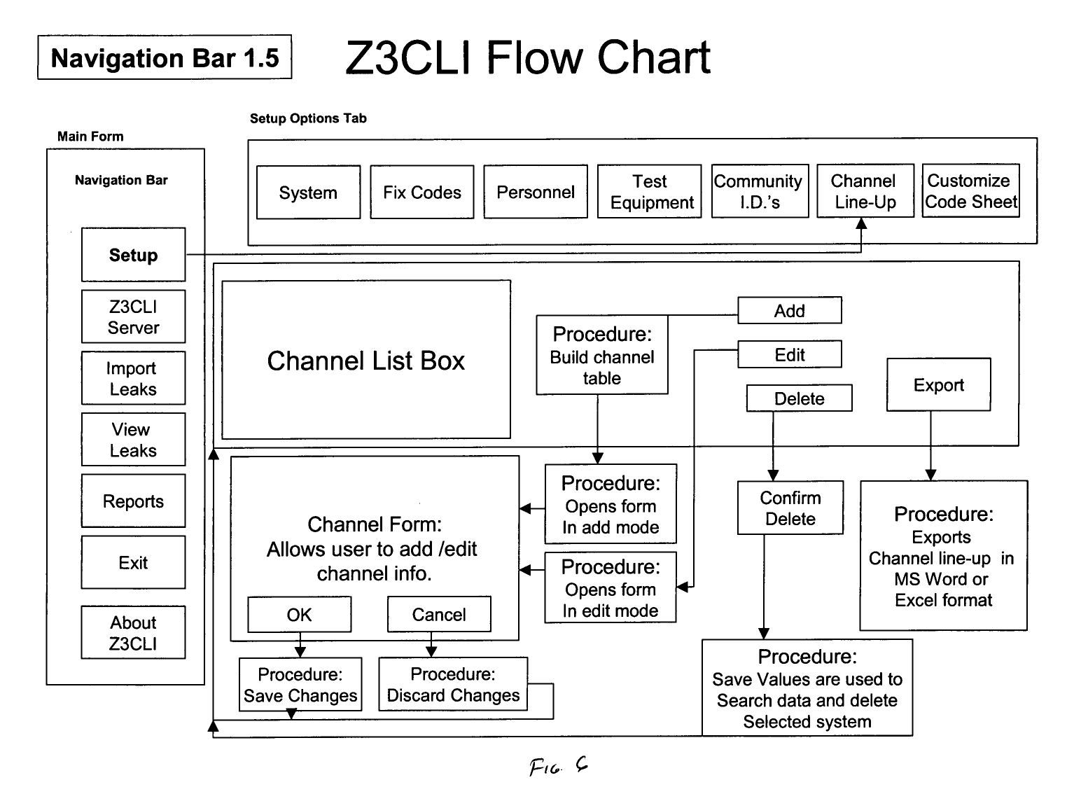

Referring to FIG. 6, the user of the system is allowed to create a channel lineup. Clicking the “channel lineup” button causes all existing channels in the system to be listed in the list box. Channels can then be added, edited, or deleted, or all of the channels can be exported into either a Microsoft Word format or a Microsoft Excel format for use in other systems. This information includes data regarding actual channels broadcast in the aeronautical band. For example, channels 14 through 40 would be listed here. The data would include the video frequency, audio frequency, and who the programmer is (e.g., HBO, Showtime, etc.). It also shows the offset, meaning the offset from the standard frequency to the aeronautical frequency.

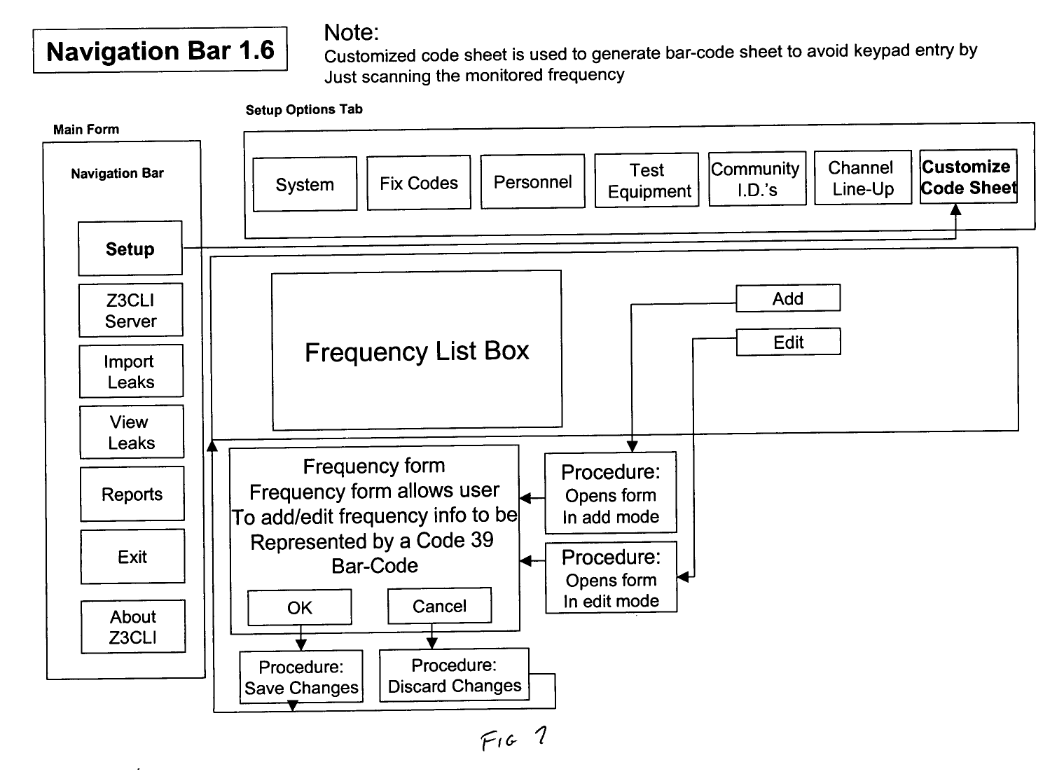

FIG. 7 illustrates the procedure that the operator of the system would use to set up, or customize, the code sheets (“cheat sheets”), which have been referred to earlier. The operator of the system may set up auxiliary fields on the bar-coded sheet so that the technician in the field, by using the sheet, can enter the data in these auxiliary fields in his individual PDA, when appropriate.

One of the key features of this invention is that a code sheet can be printed which has all of the key information which a technician may have to enter into his PDA in the course of a particular job order. Some of this information may be standard, such as the characteristics of the component which the technician is assigned to repair. Some of this information may be bar-coded representations of the fix codes, which would cover possible actions that the technician may make on a particular component. Once the technician has repaired the component, he will scan in the particular fix code for the actions he took on that particular component.

Another group of codes may be a group of codes which describe the operation of the component (e.g., good, fair, poor). When a procedure is loaded into the technician's PDA for repairing a component, the software in the hand-held computer may query the technician as to the condition of certain variables (e.g., appearance of connectors). The technician can enter response(s) to these queries by scanning the appropriate response (e.g., good, fair, poor) in bar code format into his hand-held computer.

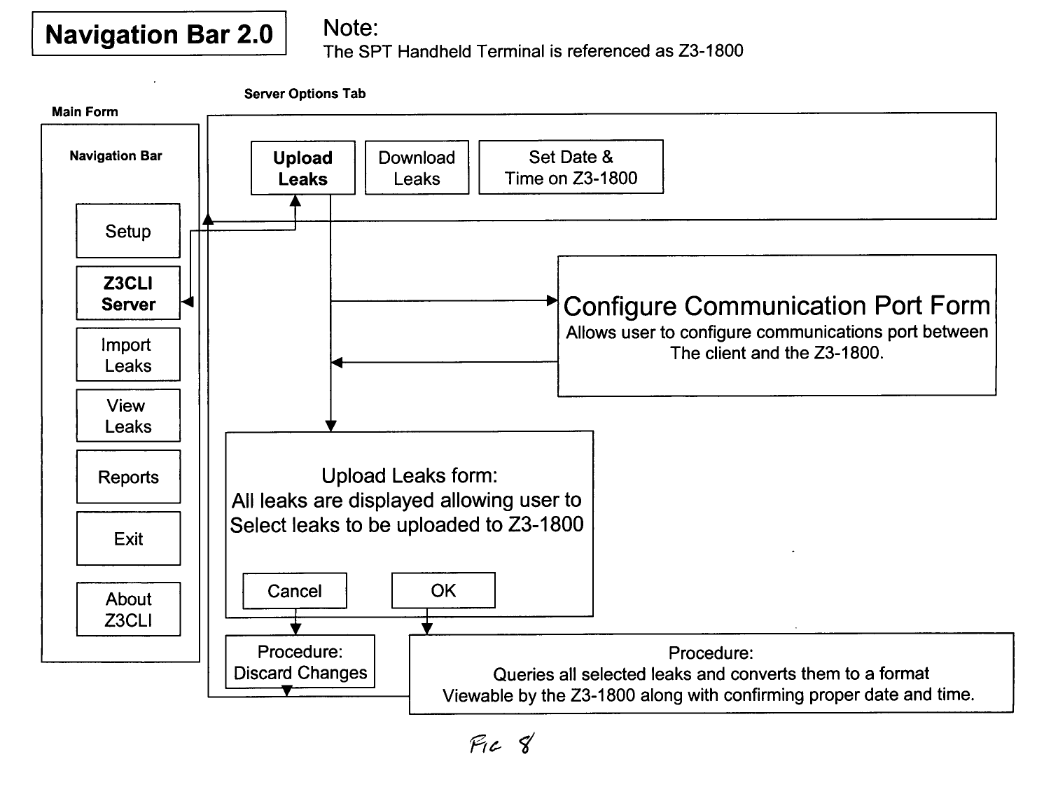

FIG. 8 illustrates the procedure by which the operator of the system may upload information regarding various RF leaks which have been stored in the system to the PDA of a technician who has been assigned to fix these leaks. This may be done by connecting the technician's PDAs physically to the system by a hard wire when the technicians are at the central office. Alternatively, radio frequency transmissions may be used to upload information to the PDAs, or download information from the PDAs.

Referring again to FIG. 8, when the “Z3CLI server” button is clicked on the Navigation Bar, a “server options” tab appears on the computer screen, which gives the operator the option of uploading leak data, downloading leak data, or setting the time and date on the hand-held terminal or PDA. Clicking the upload button allows the operator to select a group of reported leaks, and uploading the information regarding these leaks to the technician's hand-held device so that the technician will have this information when he goes to repair these leaks in the field.

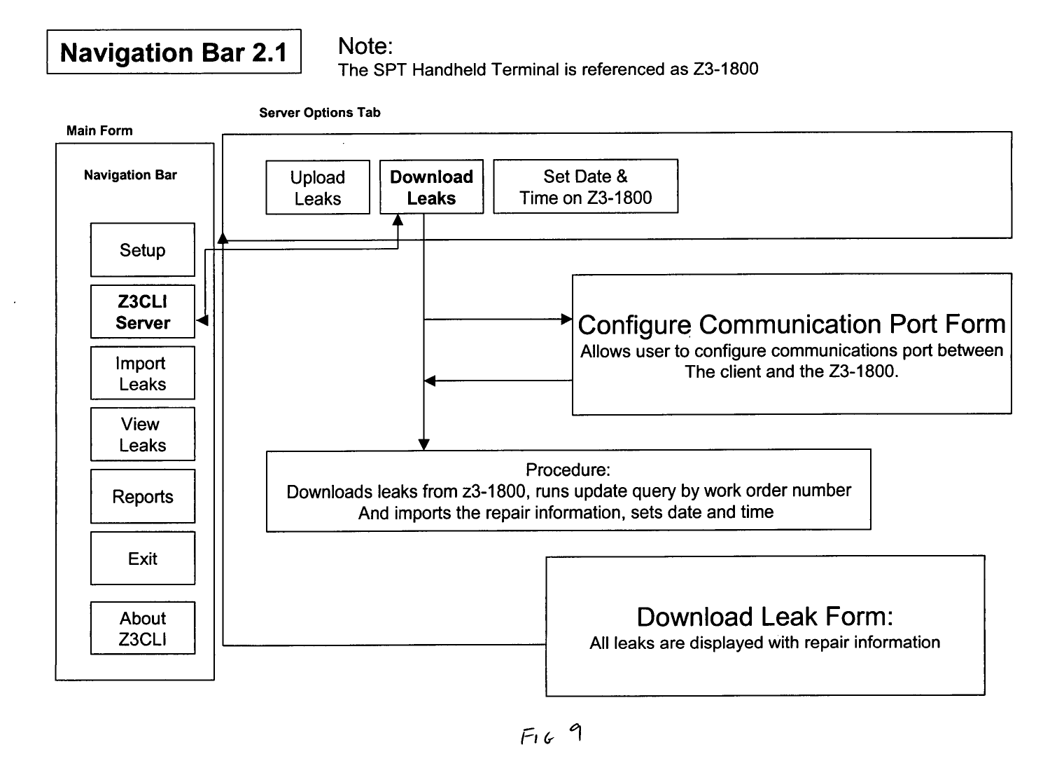

When the field technician locates the physical point at which the leak exists, he can scan in information regarding the fix code describing the action he took to repair the leak, the ambient temperature at the location of the leak, the frequency, etc. This data is stored in the hand-held device until the operator of the central system downloads it by clicking the “Download Leaks” button on the screen. in that way, the central database of leak information can be updated for eventual reporting to the FCC. This downloading procedure is illustrated in FIG. 9.

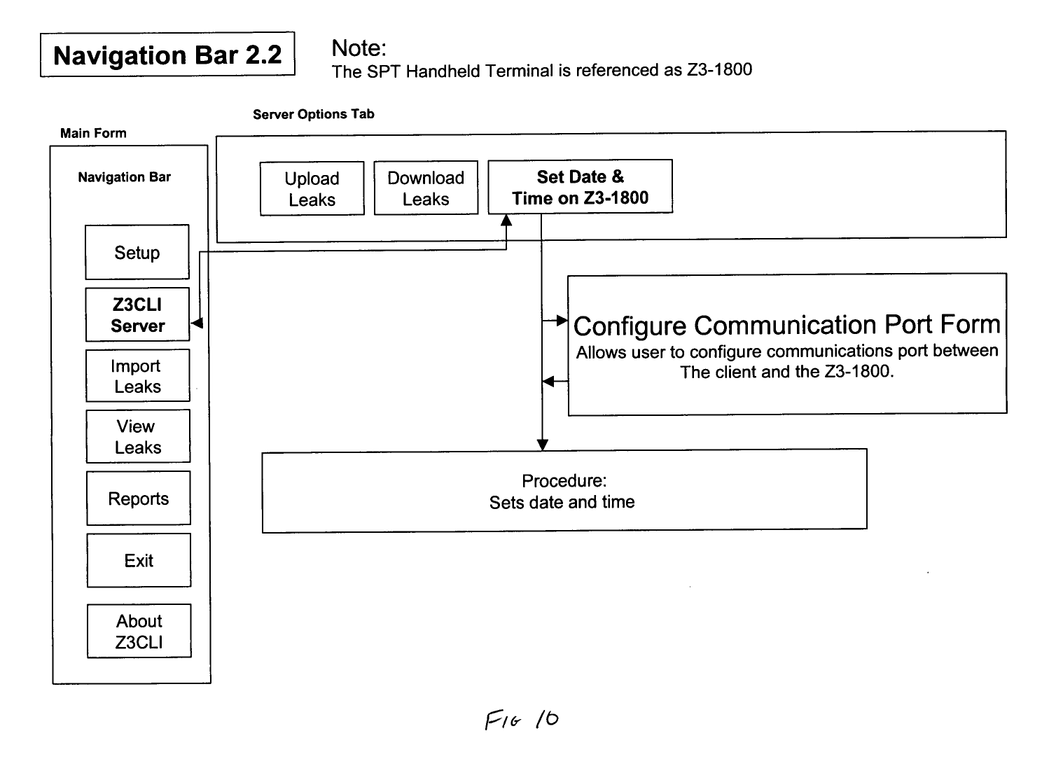

FIG. 10 illustrates the procedure for updating the date and time on the hand-held unit under the control of the main system.

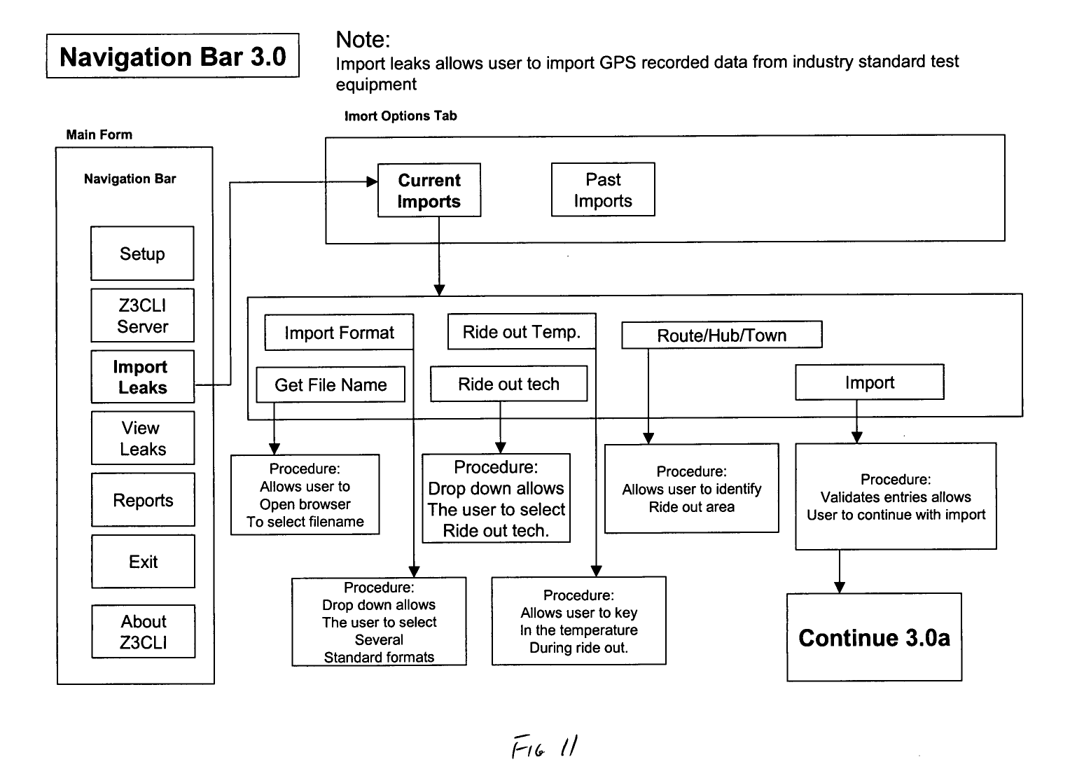

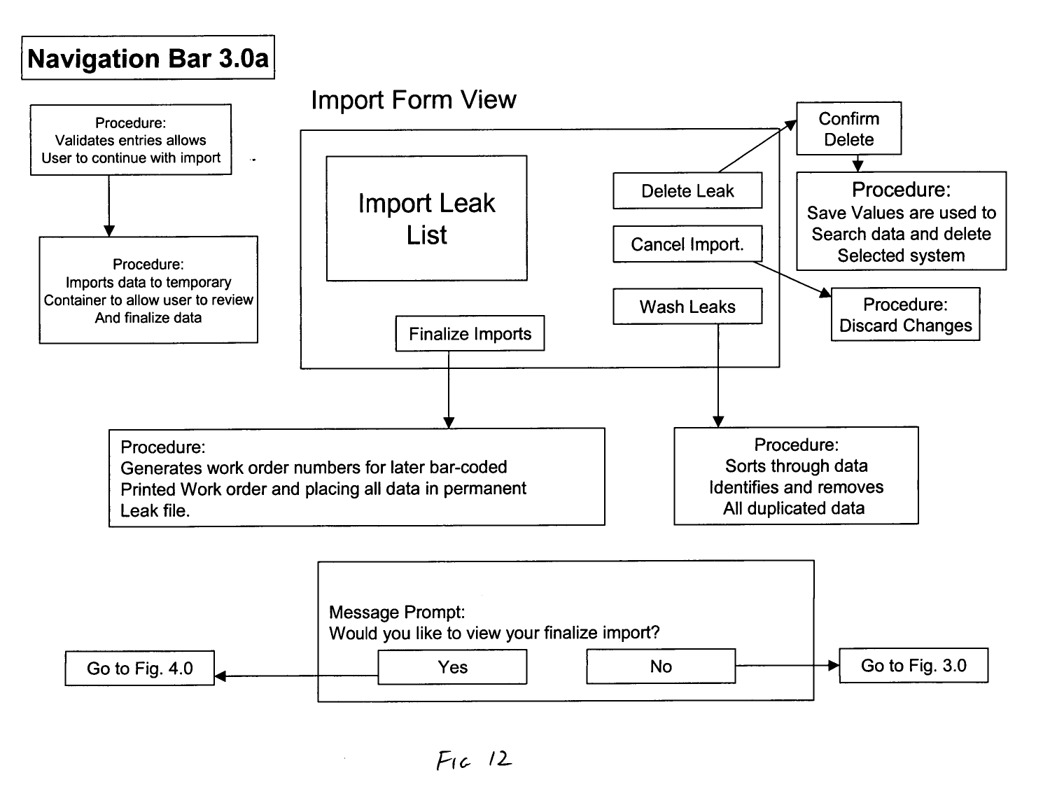

FIG. 11 and FIG. 12 show further details of the procedure for importing leak data into the central system. The procedures shown in FIG. 11 and FIG. 12 ensure that when RF leaks are reported more than once, or from more than one (1) source, they can be uniquely identified so that only one (1) record exists in the system for each particular leak.

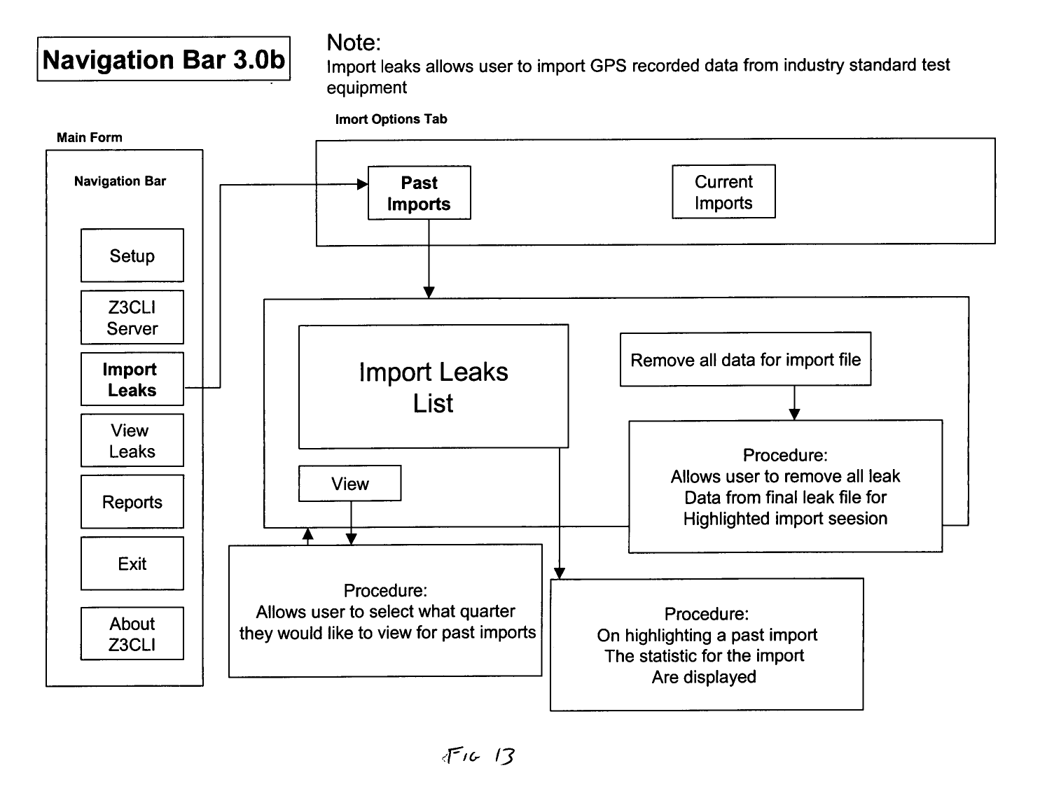

FIG. 13 illustrates the procedure in the system for looking at past imports of leak data. This procedure, coupled with the previous procedures, allows the coordination of each physical leak with one (1) particular record in the system.

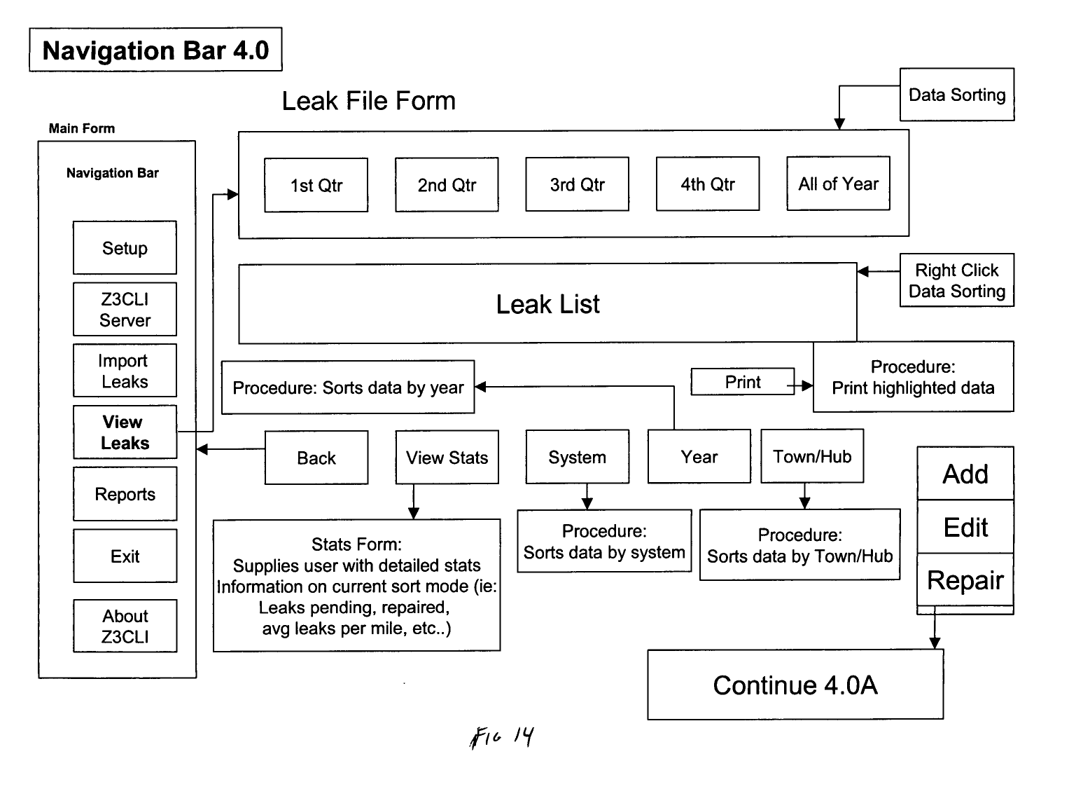

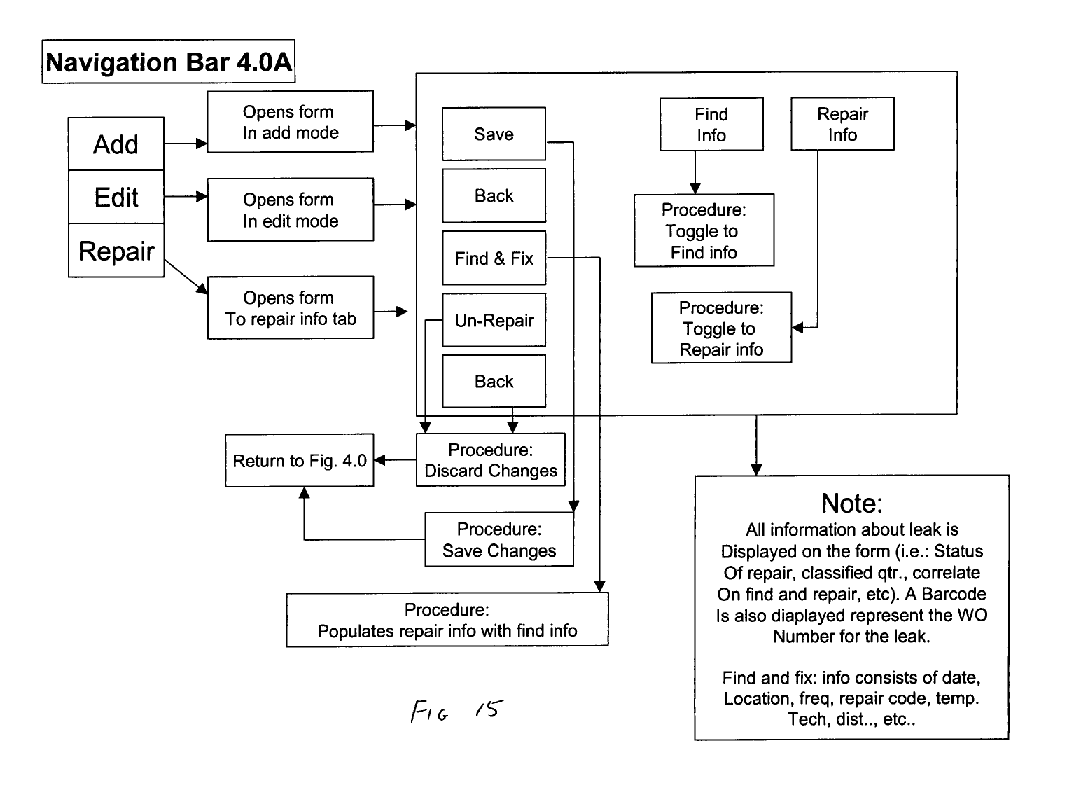

FIG. 14 and FIG. 15 show the procedure initiated by the clicking of the view leaks button on the navigation bar, which allows the user of the system to view all of the information regarding particular leaks.

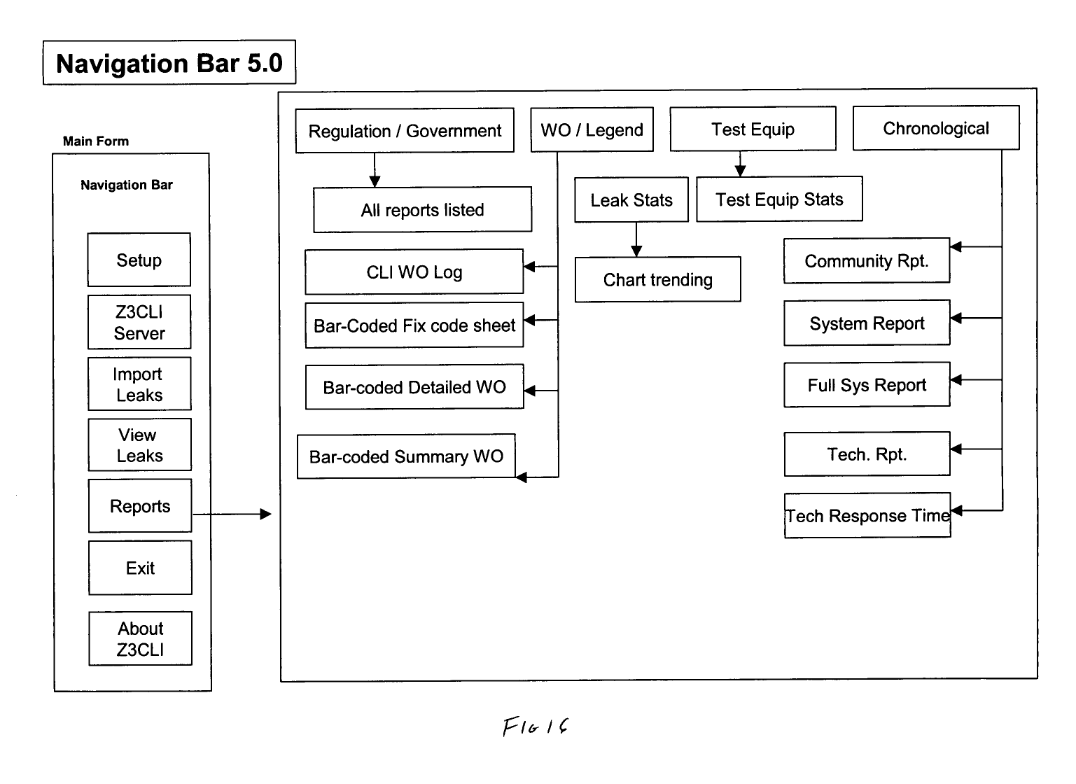

FIG. 16 shows a procedure initiated by the clicking of the reports button on the navigation bar for producing various reports based on the information on leaks in the system. Software is included, for example, to produce all required government reports to the FCC based on information collected in the system regarding leaks, their location, frequency, and actions taken to repair.

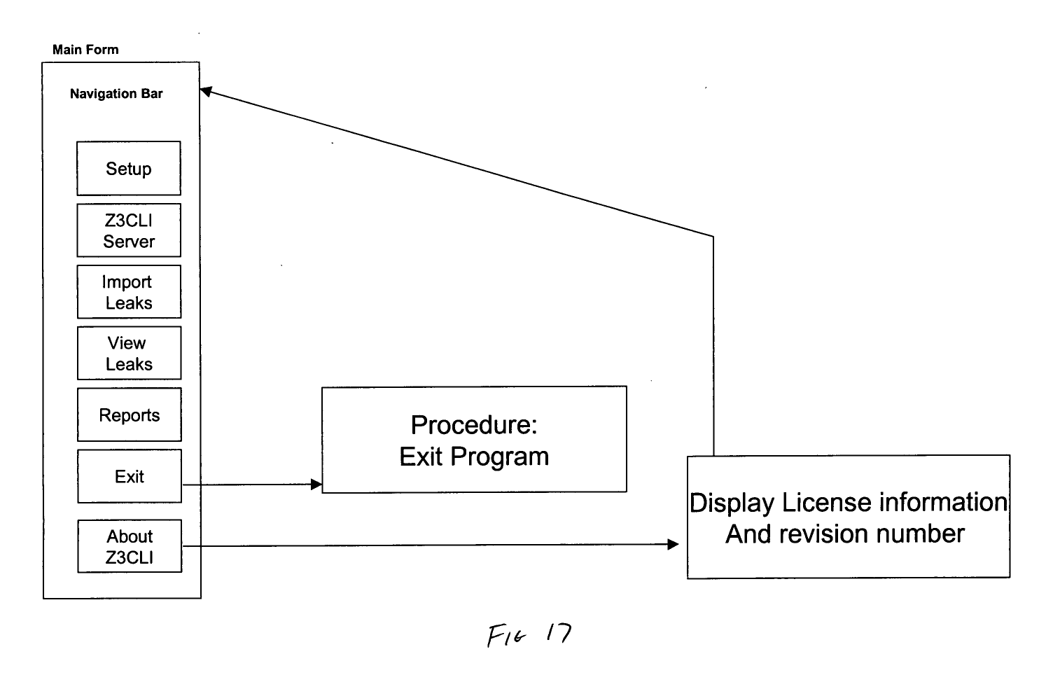

FIG. 17 illustrates the exit routine of the program.

Another unique aspect of the system is that, when the technician begins work on a particular work order, he scans the work order in from the bar code information sheet associated with that work order. This starts an internal clock running in his hand-held device. When he completes the work order number, the internal clock stops. The start and stop times, and travel times, are recorded in the hand-held device for eventual downloading to the central program. This information may be analyzed in various ways at the central office.

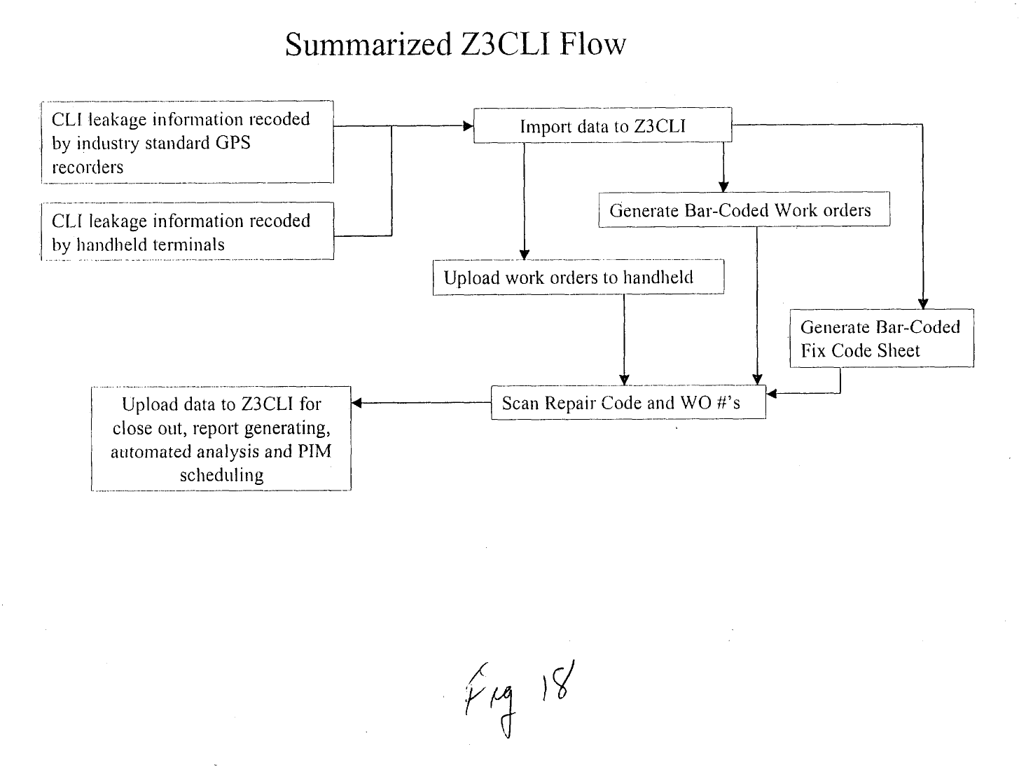

FIG. 18 illustrates the overall work flow of the procedures, which are shown in greater detail in FIGS. 1-17.

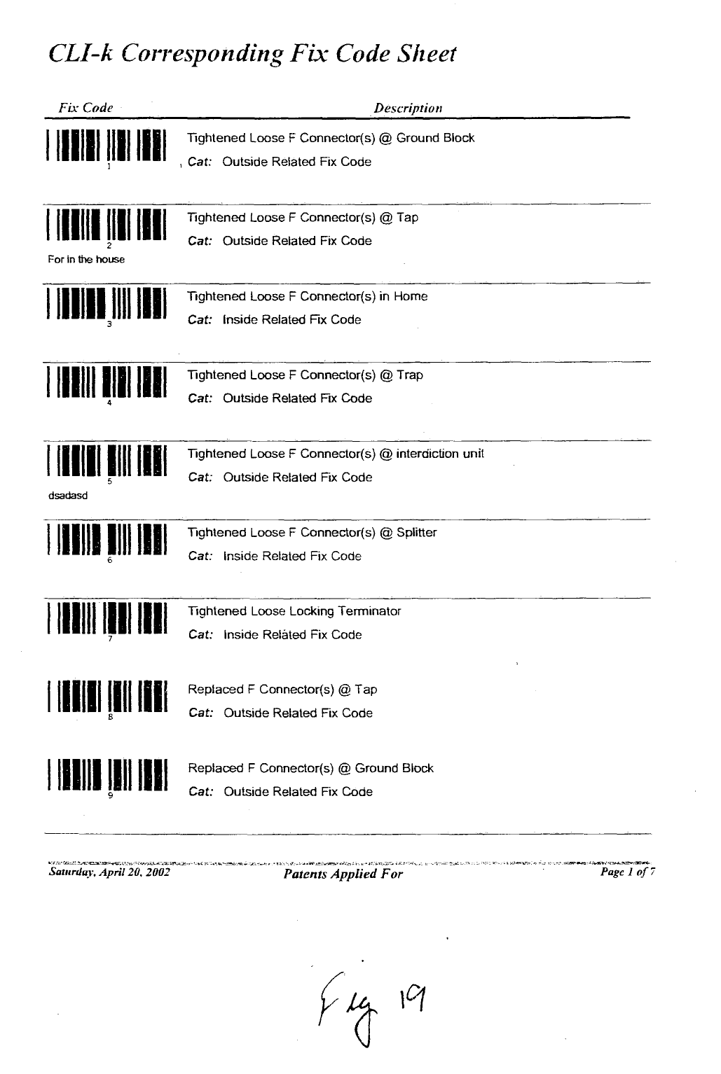

FIGS. 19-24 show code sheets with particular “fix codes,” which may be used by technicians in the field to enter data regarding the actions they took in repairing various equipment.

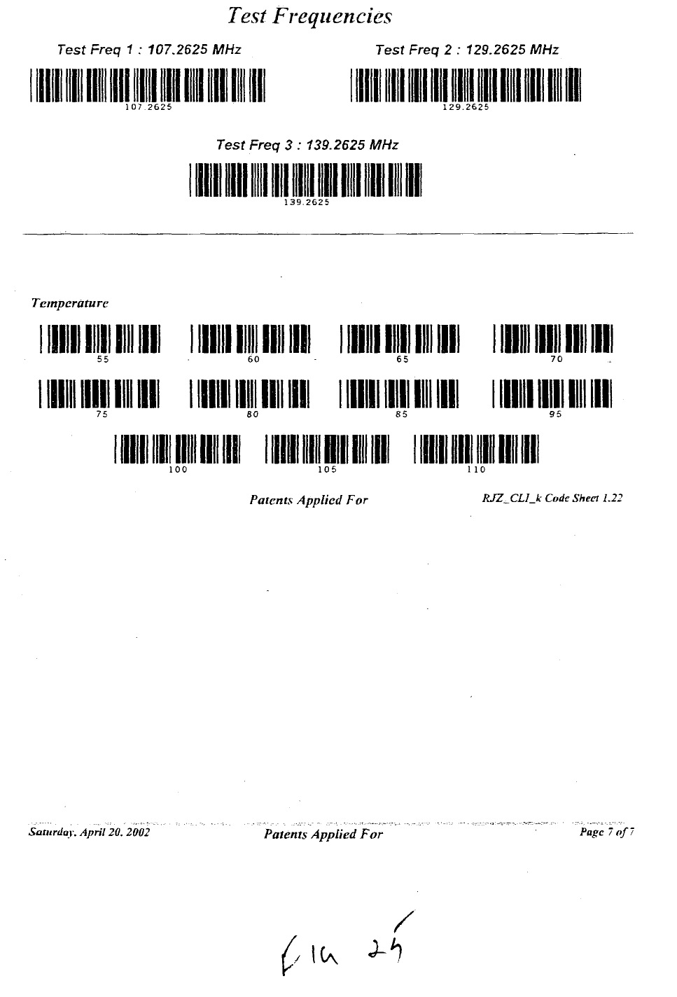

FIG. 25 shows a code sheet containing information regarding frequency, test frequency, bar code format, and temperatures in bar code format. These bar codes can be used by the technician to scan in appropriate data for a particular piece of equipment, or data regarding the operating parameters of the equipment when queried to do so, by the program in his hand-held device.

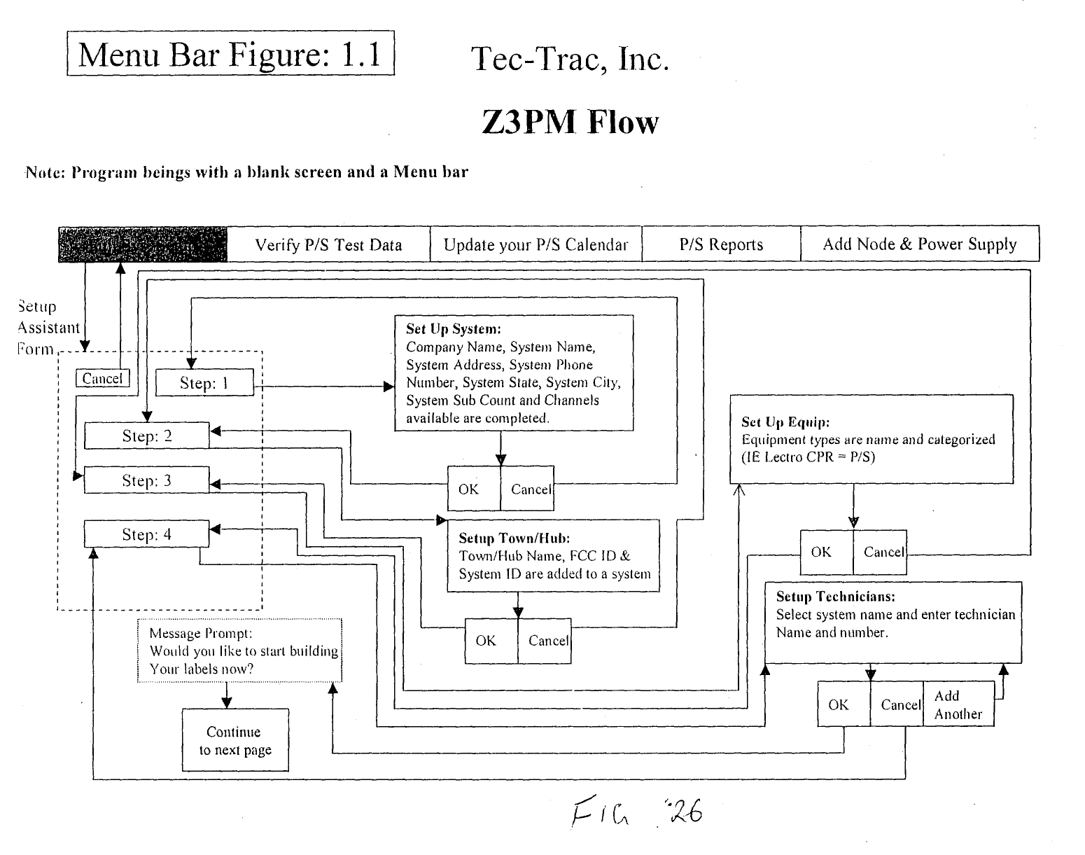

FIGS. 26-45 illustrate the system of the present invention which is used for maintaining power supplies in the field.

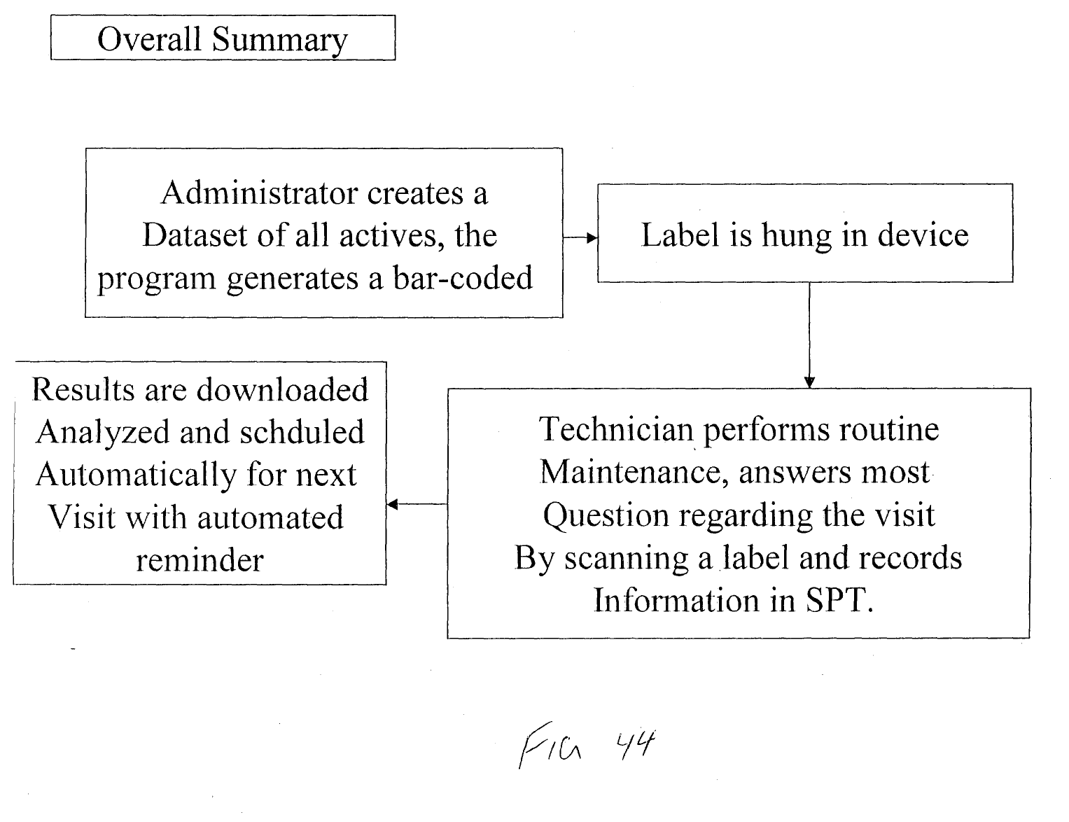

FIG. 44 illustrates the overall work flow of this procedure. The administrator at the central location source creates a data set for all activities on a particular power supply. The program generates a “Tec-Tracking label” (a bar-coded label) unique to that power supply, which is attached to each device in the field. When the technician performs routine maintenance in the field, he answers questions posed to him by his hand-held device by scanning appropriate bar codes on the label attached to the piece of equipment which he is servicing. The results, which are stored in the technician's PDA, are downloaded, either in real time or when the technician returns to the central office, and the centralized system creates a record which automatically initiates the next service call at the appropriate time.

Each Tec-Tracking label contains a label number, which is a unique number I.D. generated by the Z3PM program. The Tec-Tracking label(s) are printed, laminated, and hung in active devices. The Tec-Tracking label displays the tracking number in a bar code Code 39 format. It allows the user to visit the power supply in question, scan its label, and start recording the results for later retrieval and automated analysis. This eliminates the need of writing down test locations. The program will automatically tie that number with a street location on download. The Tec-Tracking label(s) are printed in a regular ink jet, or laser, printer, on plain paper, and folded in half. When folded, the Tec-Tracking label(s) have a “cheat sheet” on the back, which is set by the user for the staff to scan in results without the need of typing them in.

FIG. 26 is a flow chart illustrating how to set up the desktop program at the central office of the cable television company. The setup allows the operator to verify power supply data, update the power supply calendar, which record dates of service (past and future), etc. The user is prompted to enter appropriate information into the system, as is shown in FIG. 26.

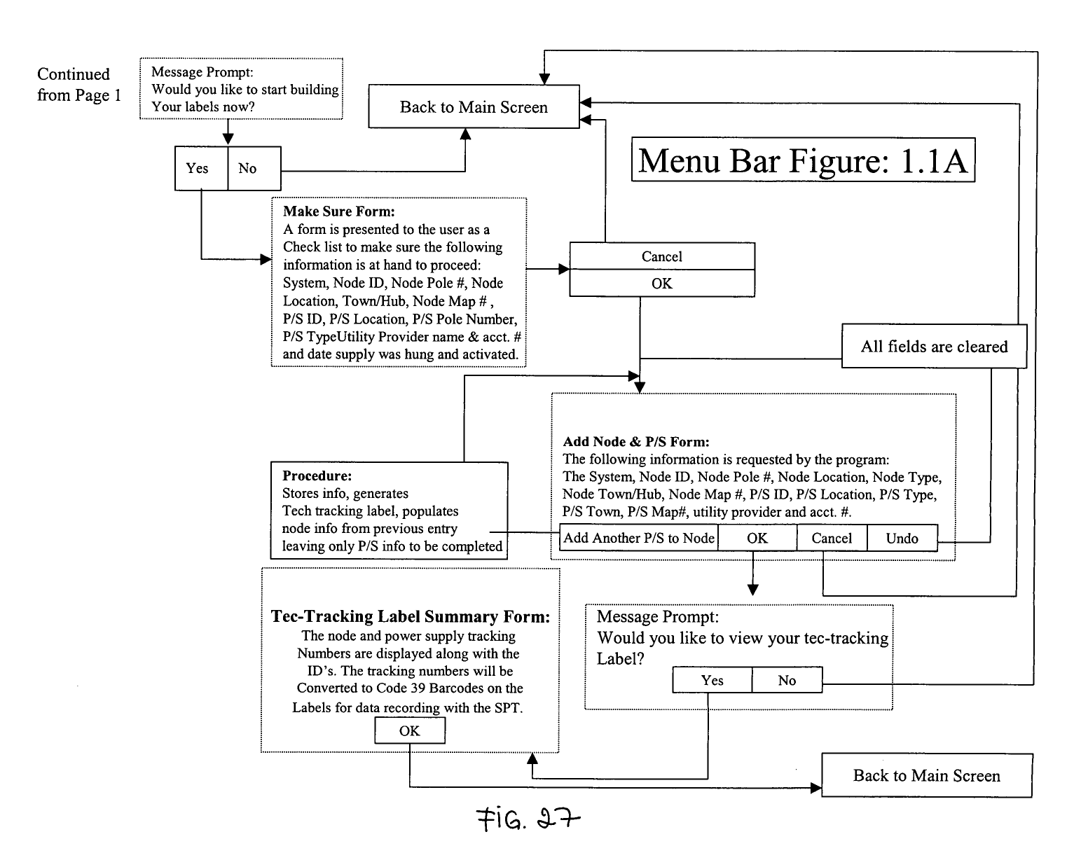

FIG. 27 shows a flow chart for building bar-coded labels tied to every active device in the system. These bar-coded labels are also unique to particular physical location(s) in the system where the equipment is located. As illustrated in FIG. 9, these labels have detailed information regarding the characteristics of the equipment, location of the equipment, and connections to electrical utilities. This information can be scanned into the technician's hand-held device when he arrives at the location to service the power supply, and is available to him if needed. For example, if he needs to contact the power company which powers the particular power supply in the system, the information needed to contact the power company is available to him at the power supply.

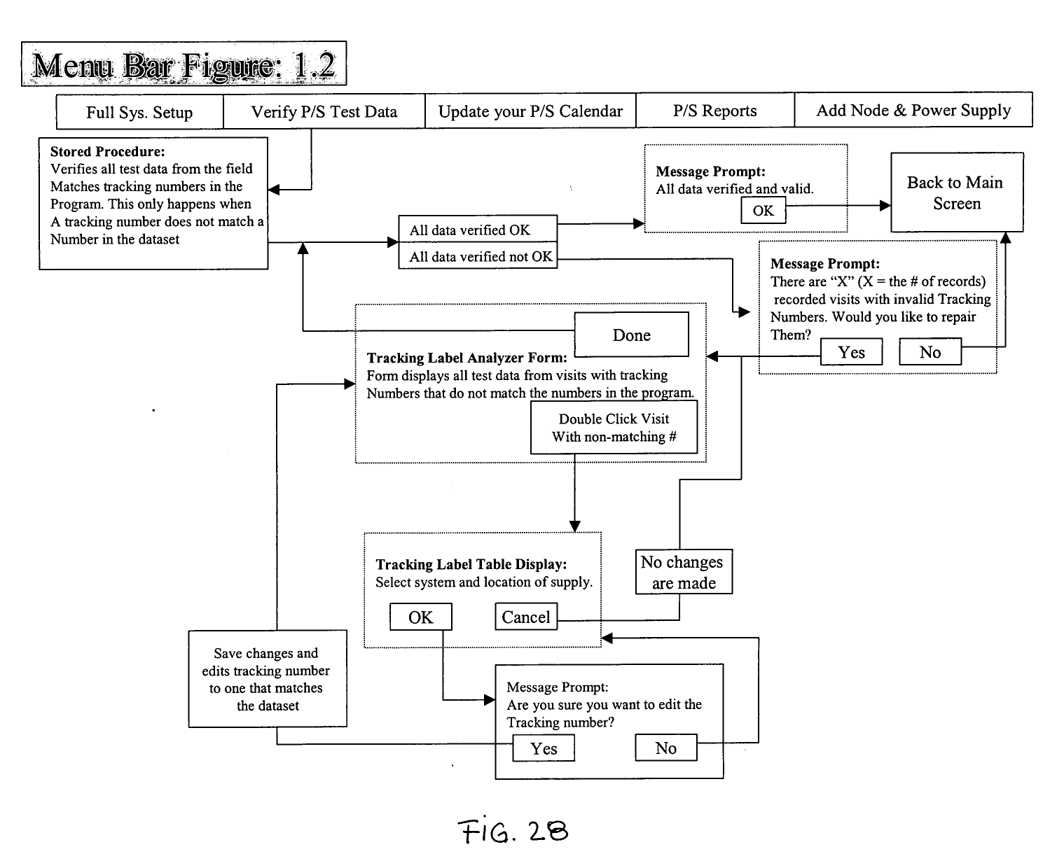

FIG. 28 illustrates a procedure in the system for verifying test data from the field.

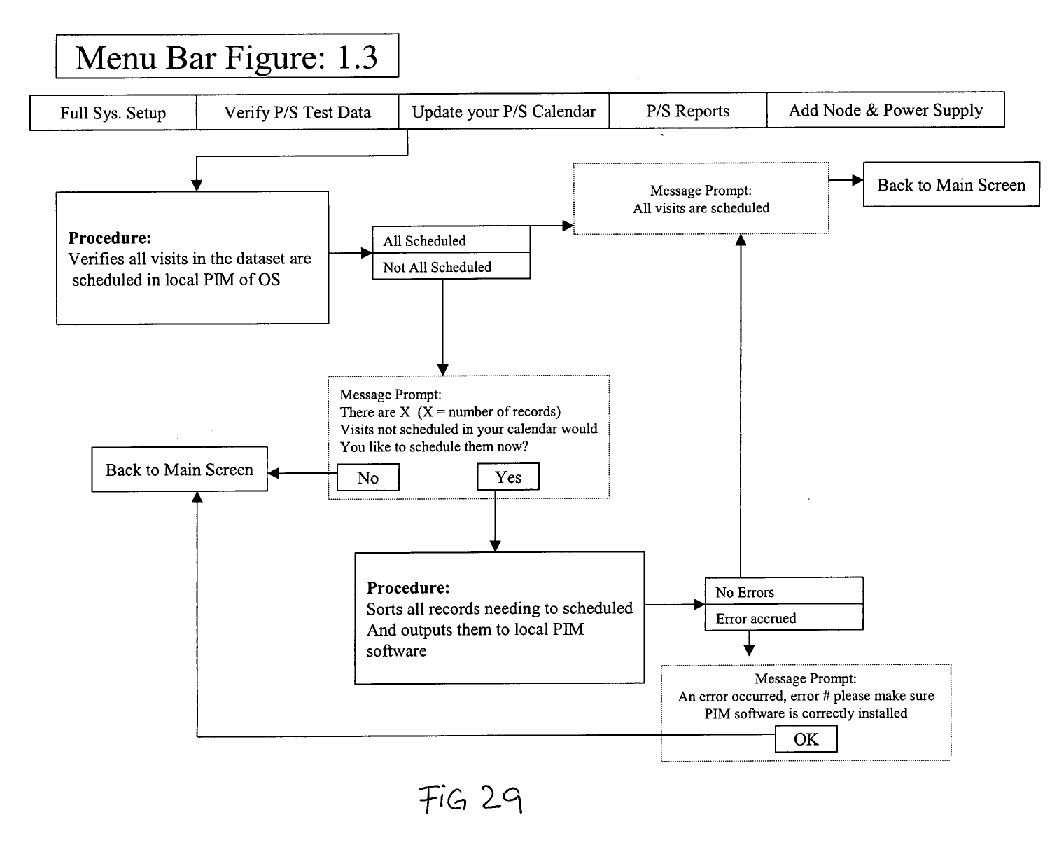

FIG. 29 illustrates a procedure contained in the system for updating personnel management software, such as Microsoft Outlook, so that, for example, scheduled appointments for re-visiting particular power supplies may appear in a Microsoft Outlook calendar.

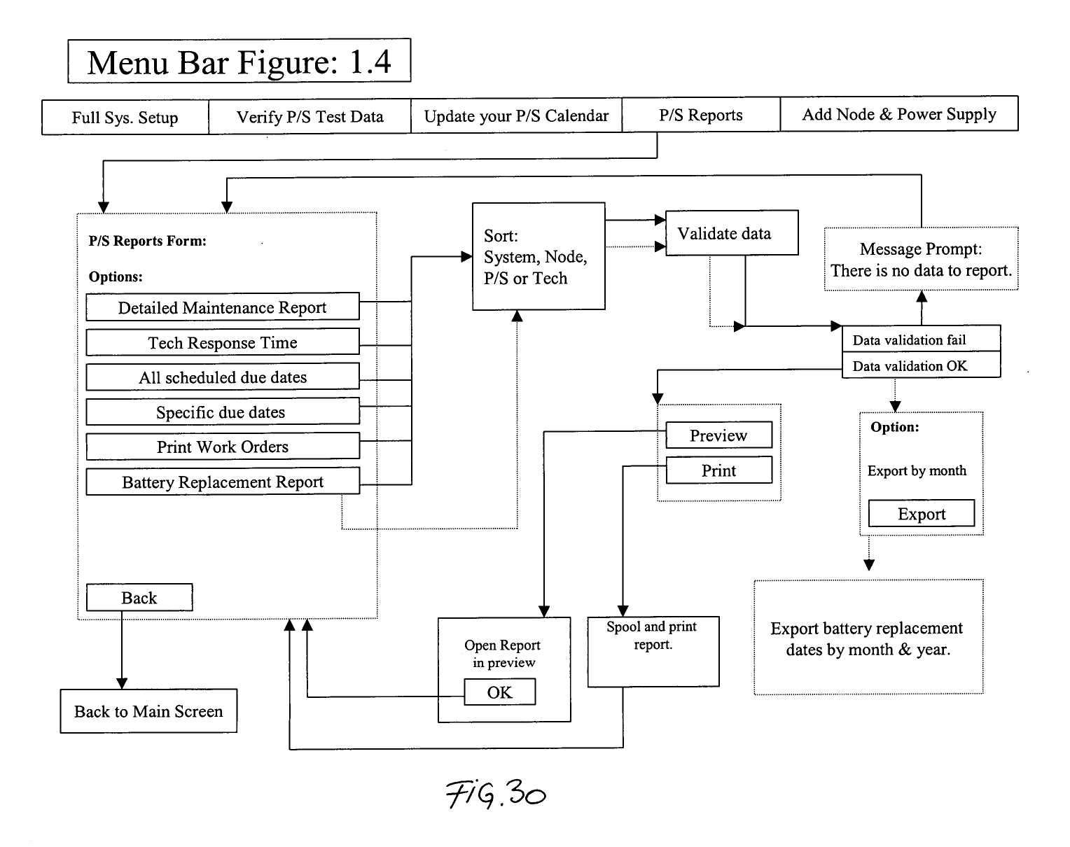

FIG. 30 illustrates a procedure for allowing the user to report on any test data received in various report formats.

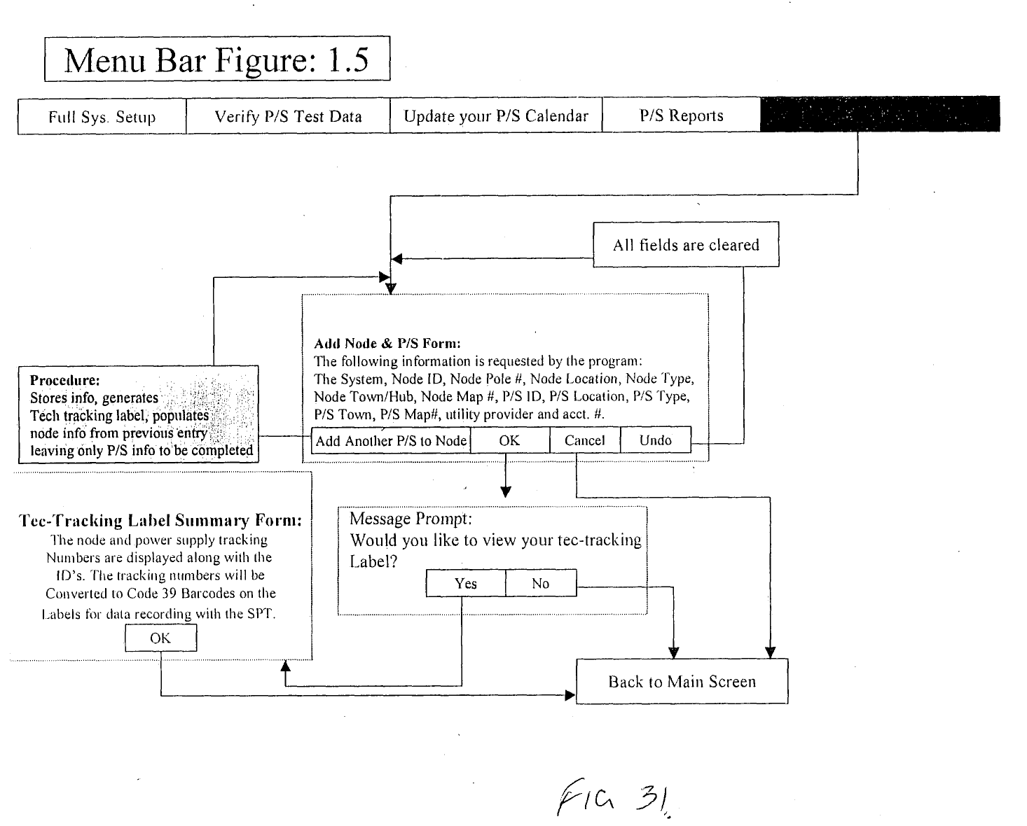

FIG. 31 illustrates a procedure in the system for adding a node and a power supply into the database.

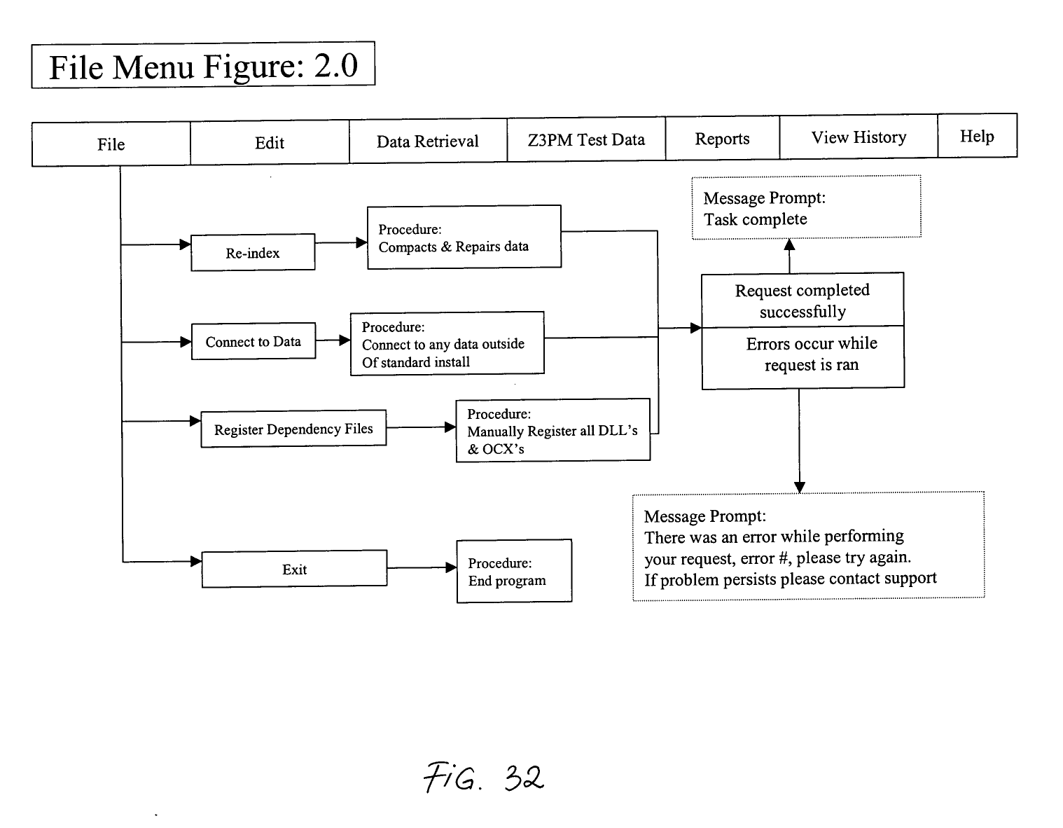

FIG. 32 illustrates software in the system for compacting the data, and repairing data in the database.

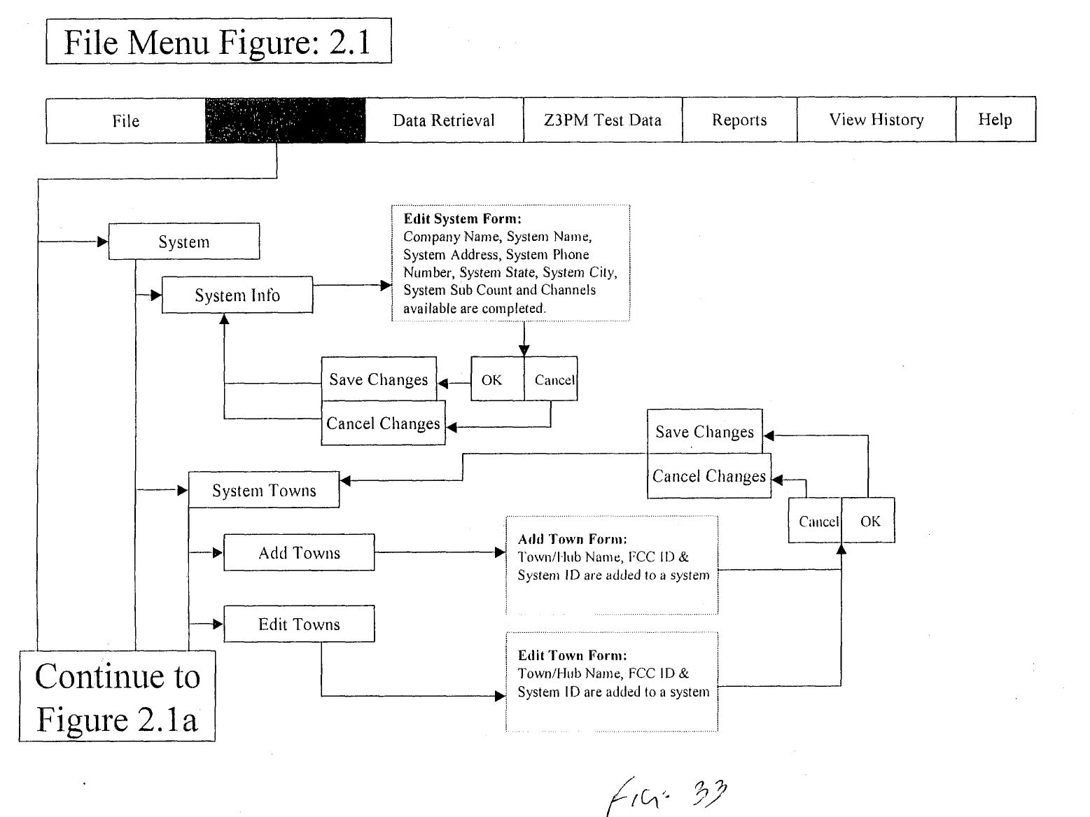

FIGS. 33-36 illustrate the software contained in the system for editing the information in the database.

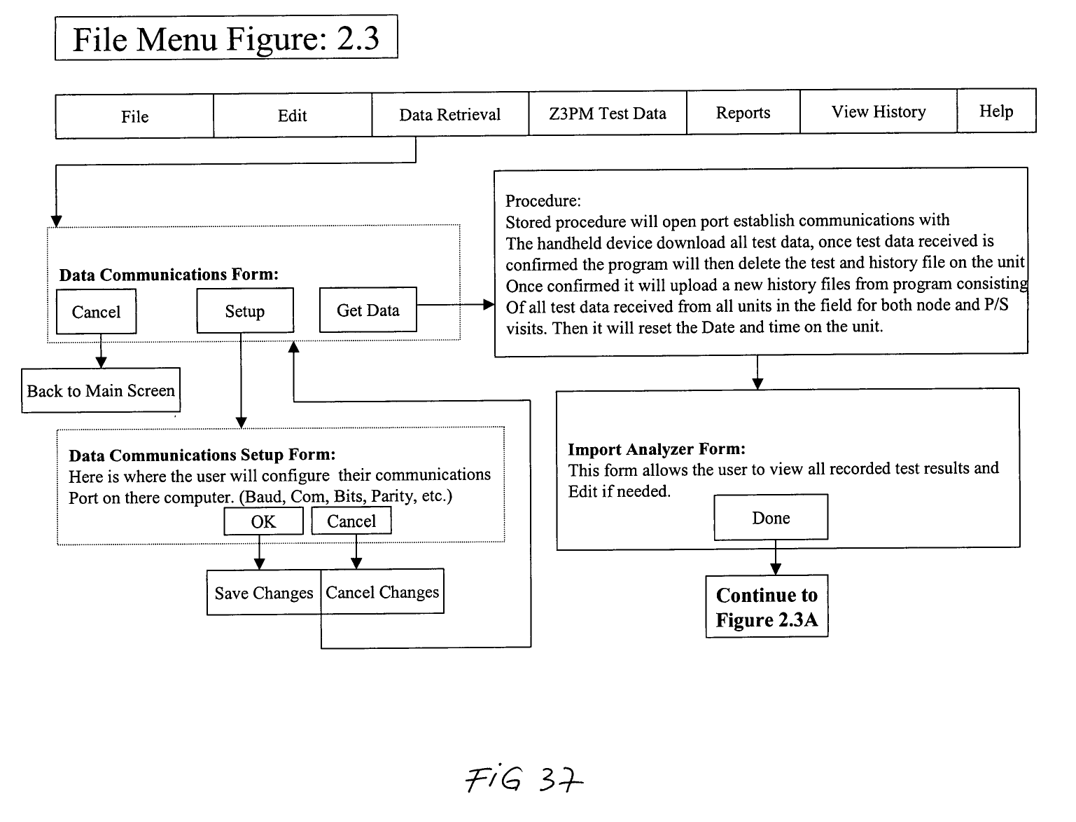

FIG. 37 illustrates software contained in the system for printing the power supply labels, which are discussed previously.

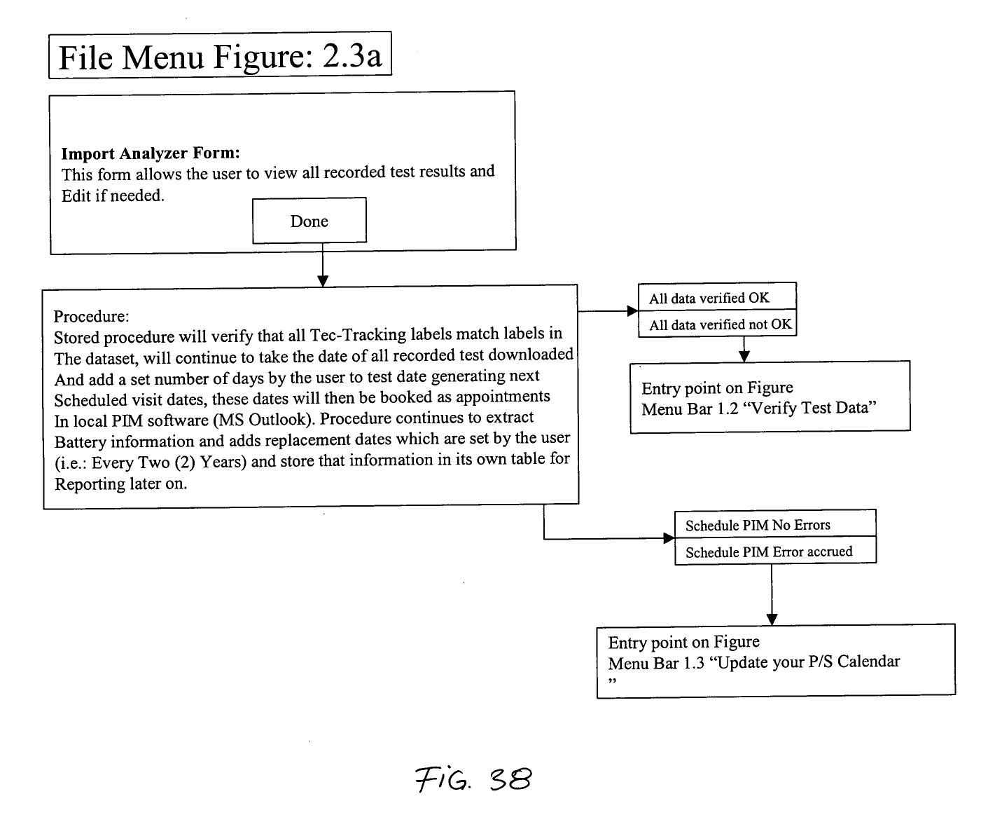

FIG. 38 illustrates software in the central system for downloading data from the technician's hand-held device and storing them in the central system.

FIG. 38 illustrates software in the system for analyzing the data which has been imported from the technician's hand-held device. It shows all visits which were recorded by a hand-held device, the time they started, the time they finished, the technician(s) who performed the visits, etc. Entries are made to set the number of days to elapse before the next scheduled visit, and puts these visits in a calendar, such as Microsoft Outlook. The procedure also extracts date(s) regarding backup batteries from the technician's report, and schedules replacement dates for the batteries.

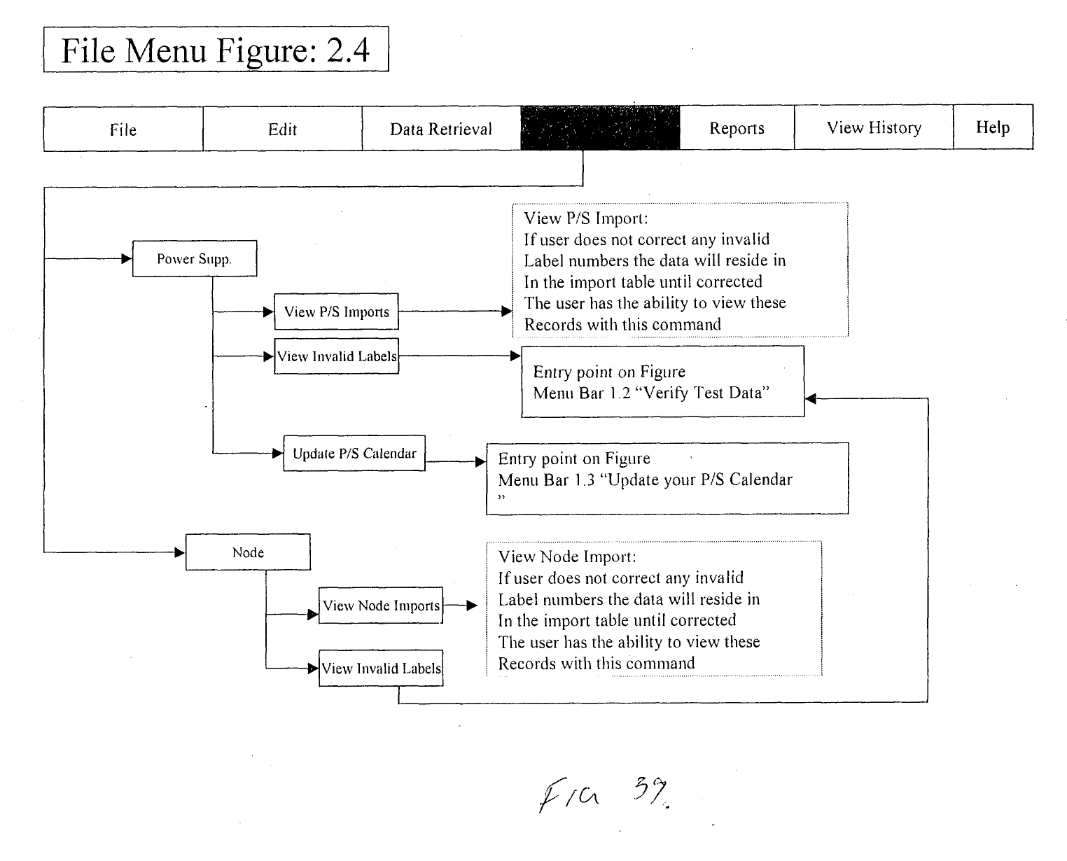

FIGS. 39-43 show procedures in the system for verifying, and analyzing, the data collected from the hand-held devices.

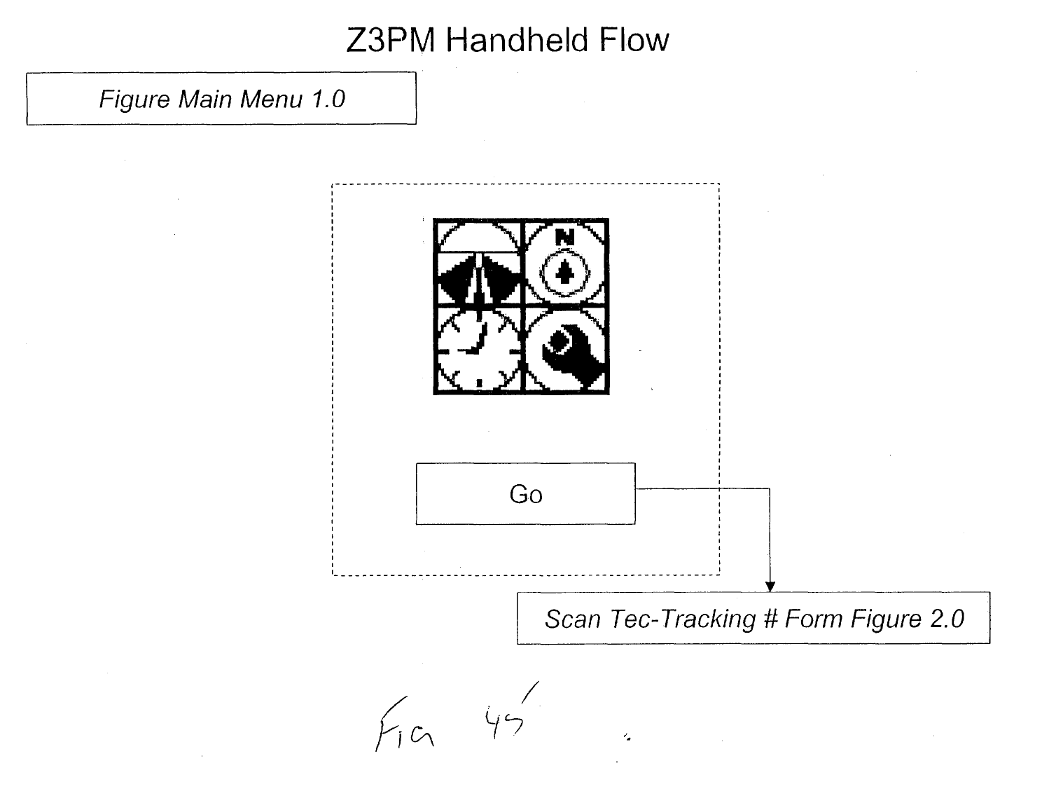

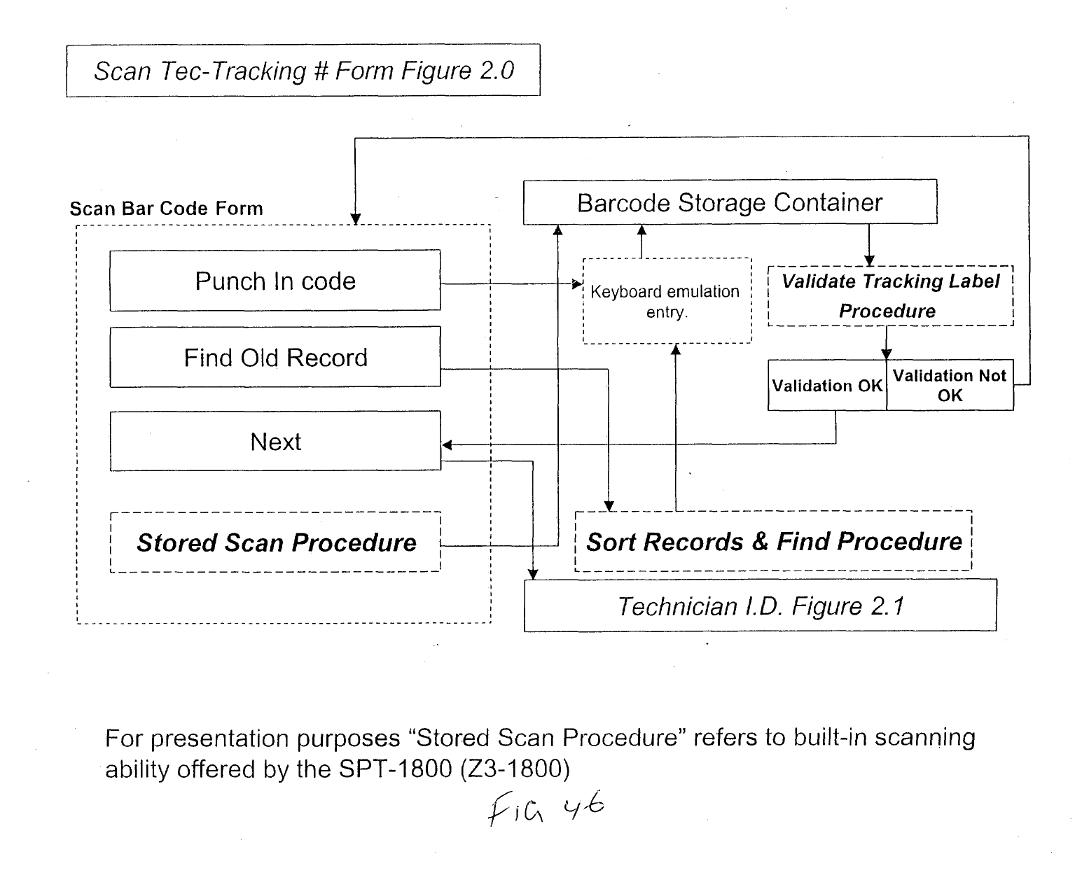

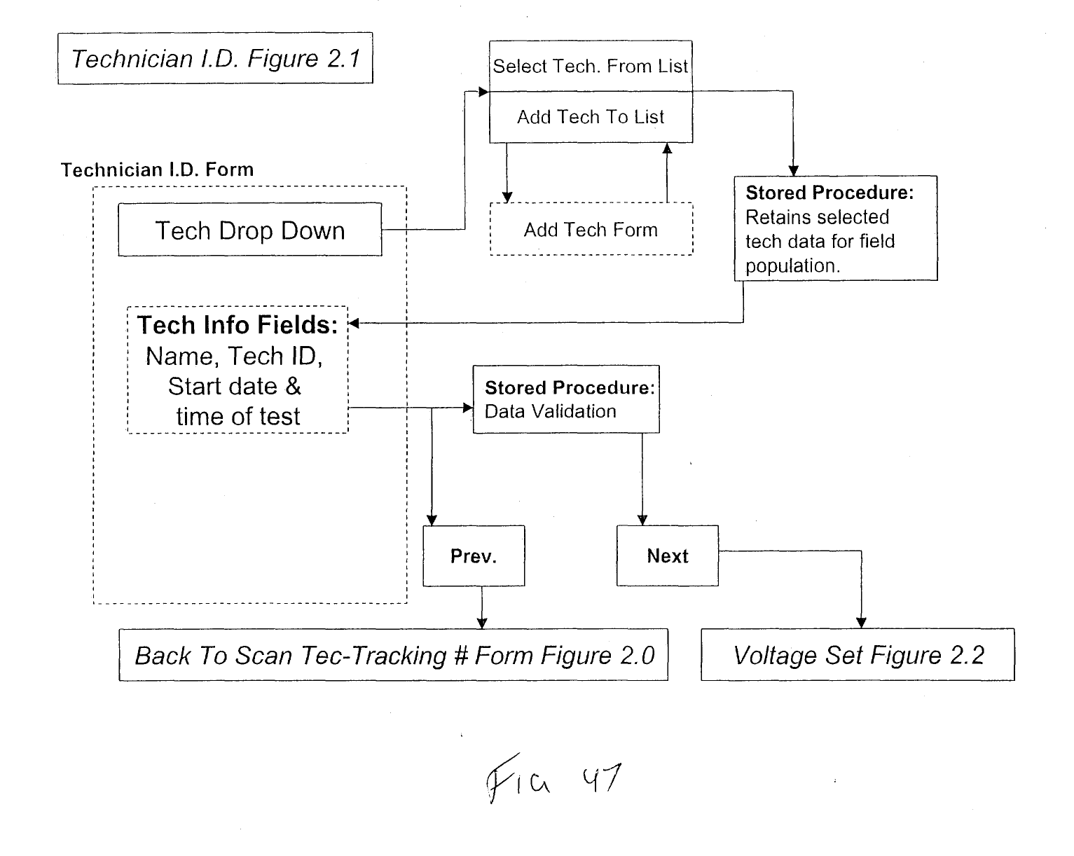

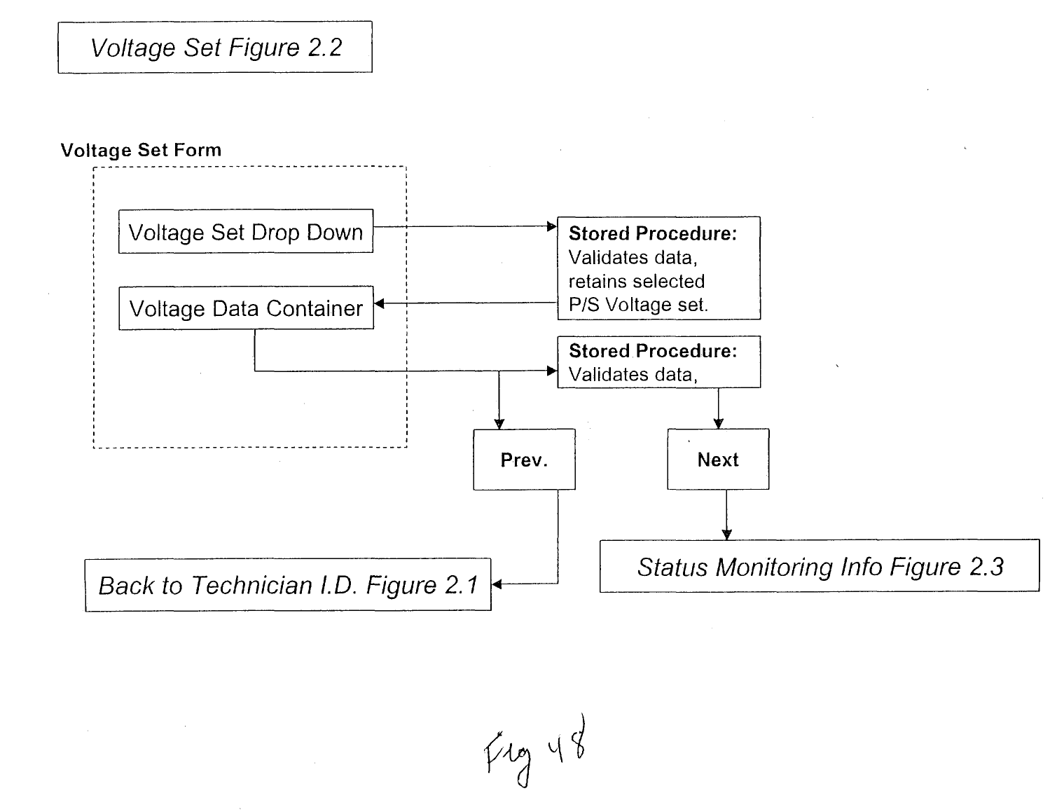

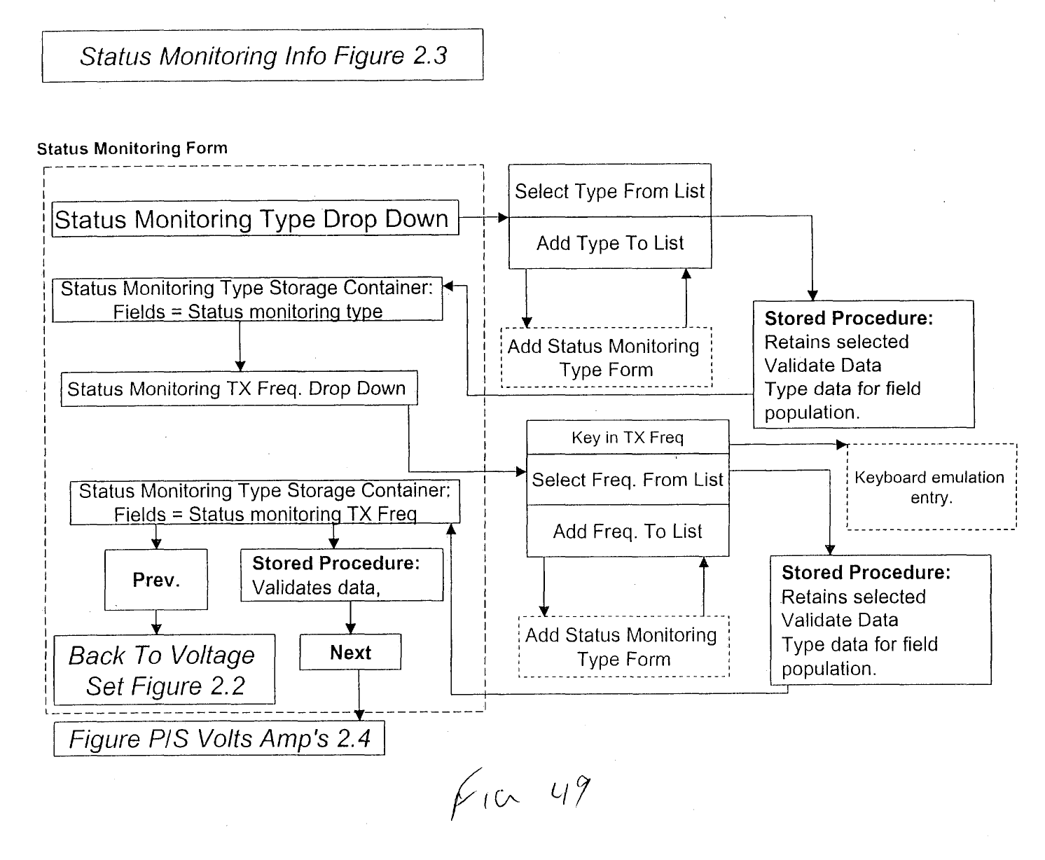

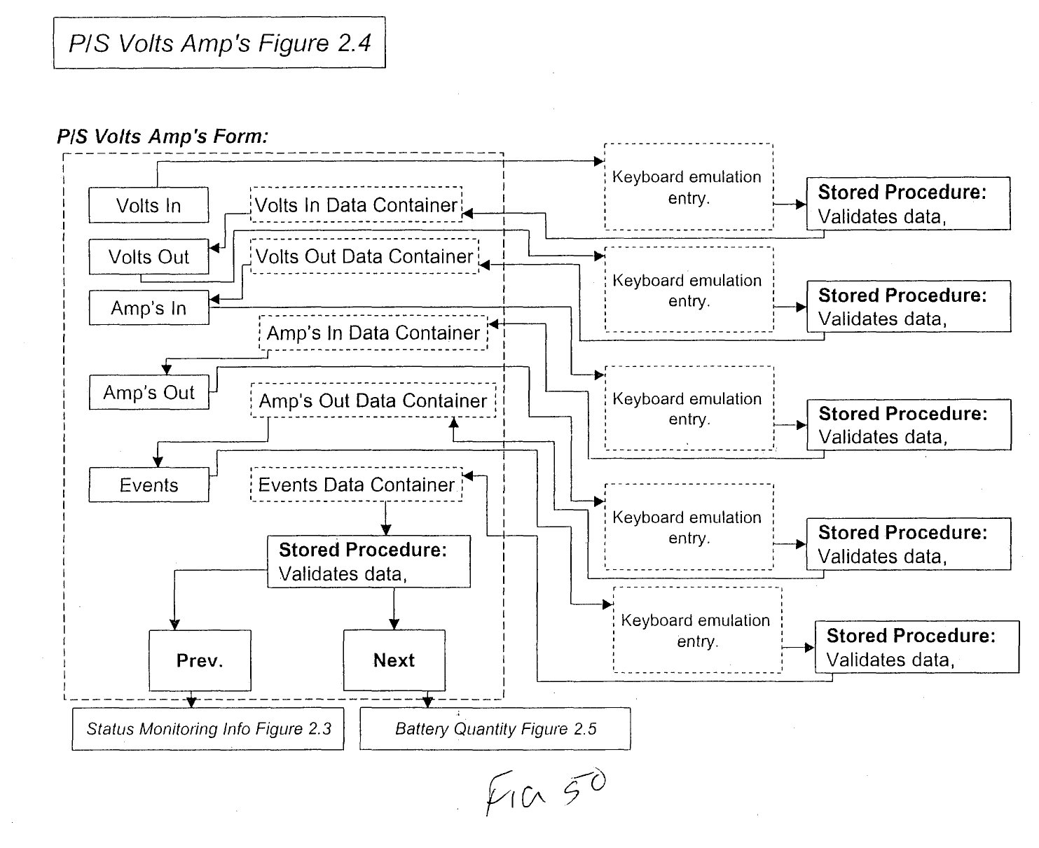

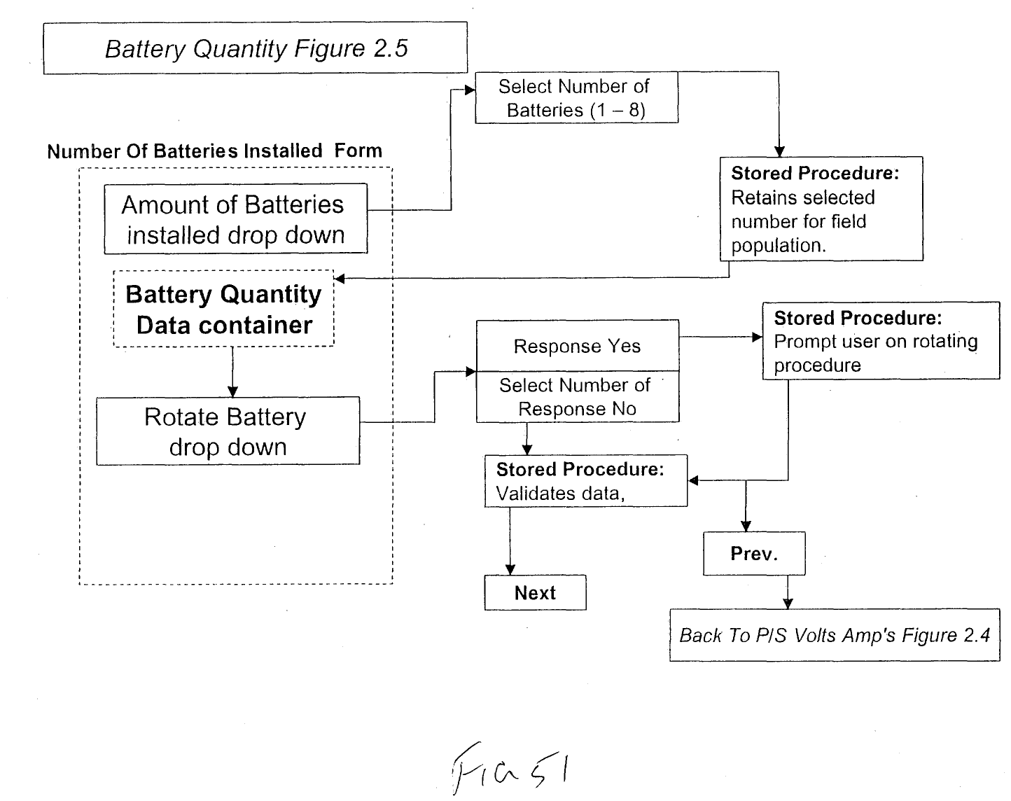

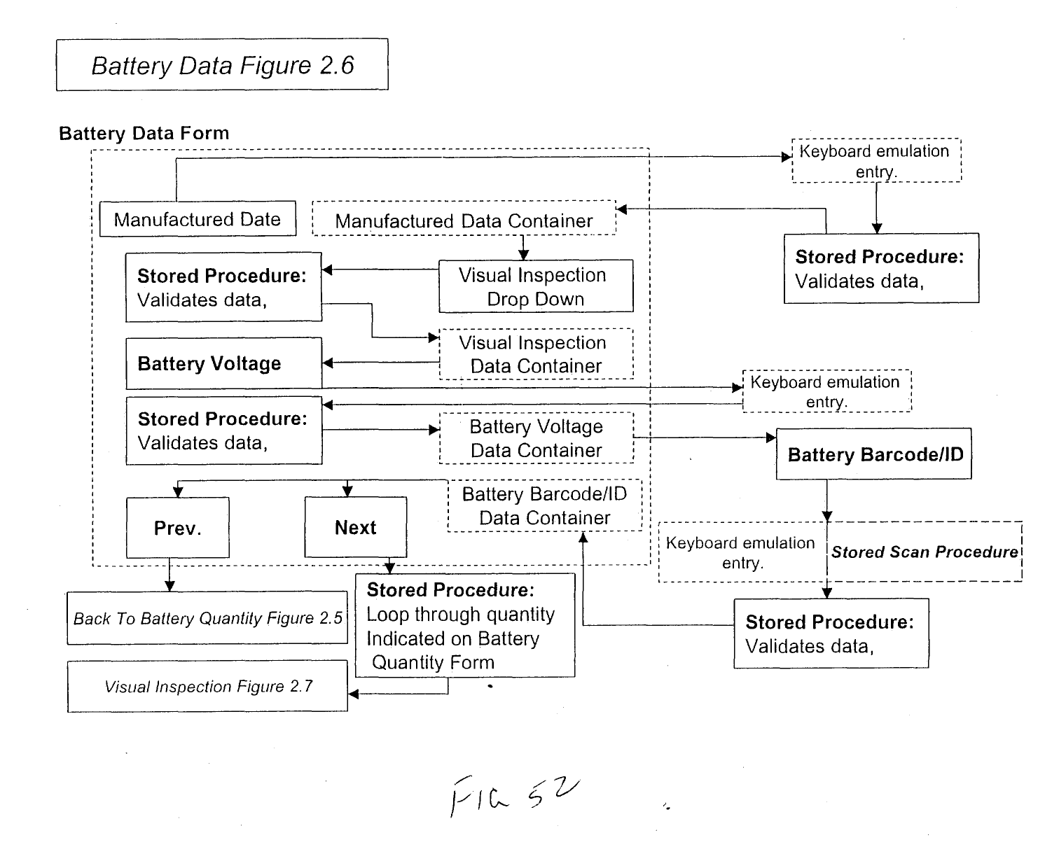

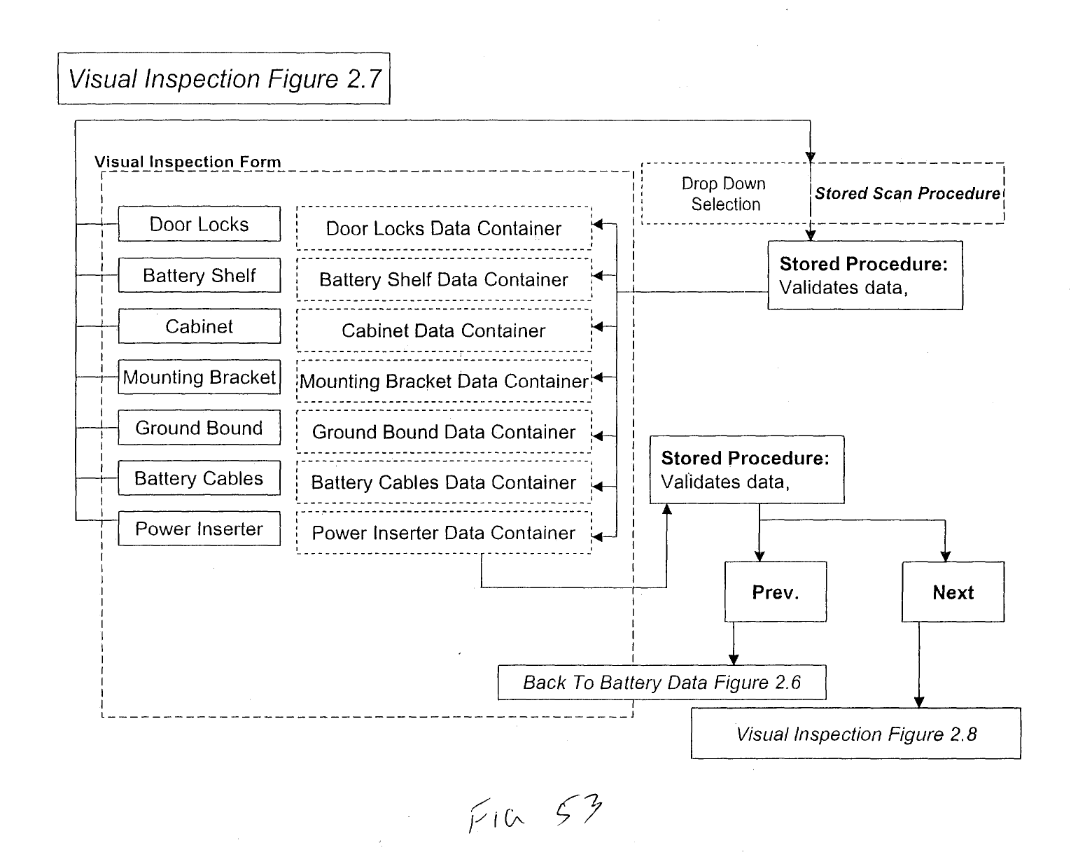

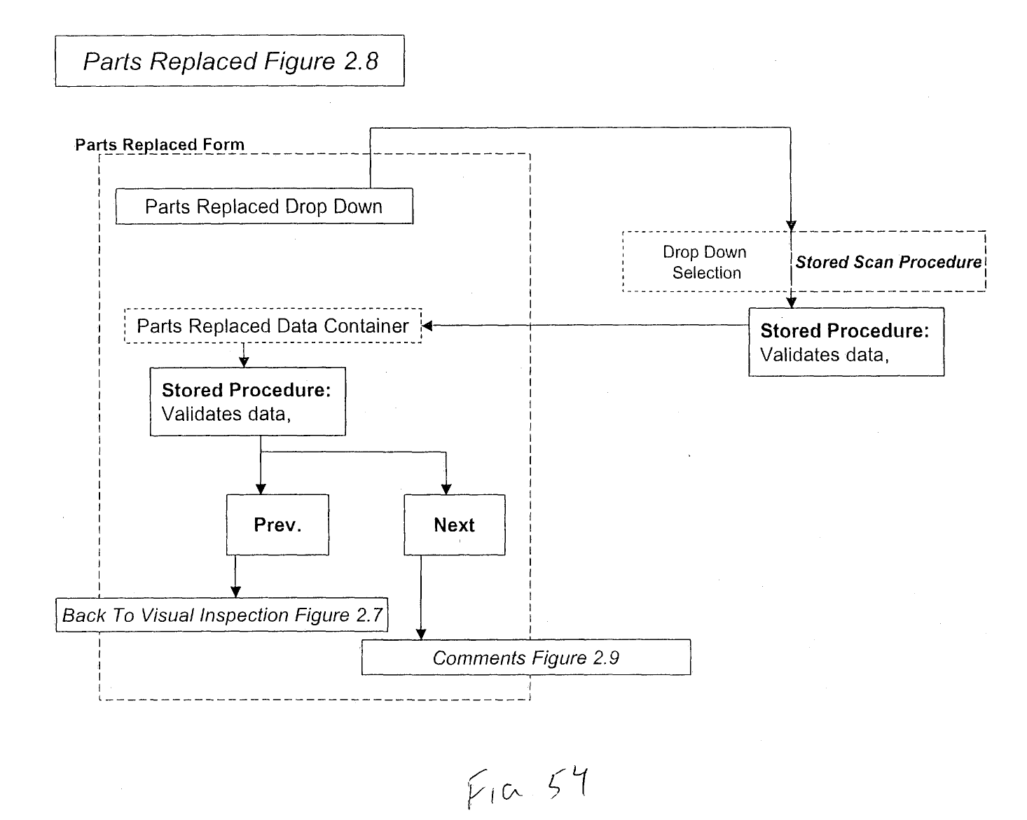

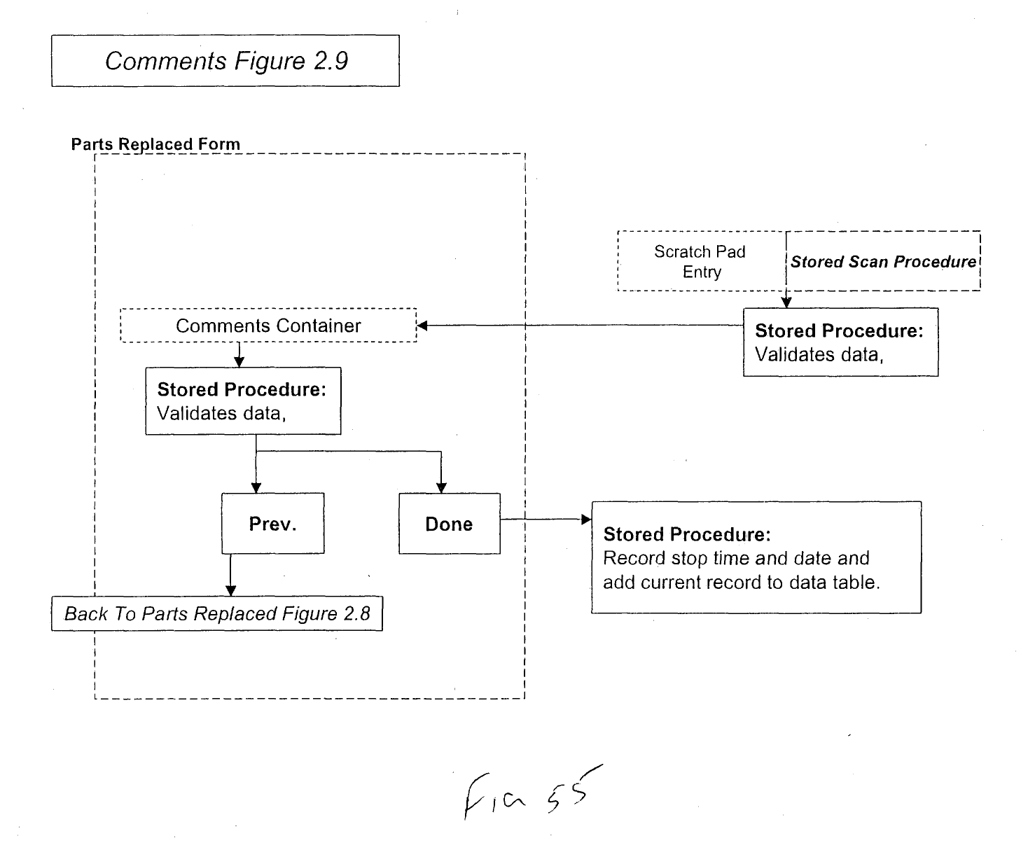

FIGS. 45-55 illustrate, in flow-chart form, software in each hand-held device for assisting the technician to service power supplies in the field, and enter information from the data sheets attached to each power supply. Software is also contained to accept data from the central system, and download the data to the central system.

FIG. 1 is an illustration of the initial display provided by the desktop portion of the software system, which implements the present invention.

FIG. 2 is a block diagram of the procedure embodied in the software under which a user can set up “fixed codes” by completing information in a “fixed code form.”

FIG. 3 is a block diagram showing the procedure embodied by the invention for updating information in the system regarding field technicians.

FIG. 4 is a block diagram illustrating the procedure for updating information in the system regarding test equipment.

FIG. 5 is a block diagram illustrating the procedure embodied in the invention for updating “community ID” information stored in the system.

FIG. 6 is a block diagram showing the procedure embodied in the invention for creating a “channel lineup.”

FIG. 7 is a block diagram illustrating the procedure embodied in the system for customizing “code sheets.”

FIG. 8 is a block diagram illustrating the procedure embodied in the system for uploading information regarding RF leaks which have been stored in the PDA of a technician.

FIG. 9 is a block diagram illustrating the procedure embodied in the system for uploading information regarding RF leaks which have been stored in the PDA of a technician.

FIG. 10 is a block diagram illustrating the procedure embodied in the system for updating the date and time on a hand-held unit.

FIG. 11 and FIG. 12 show further details of the procedure for importing leak data into the central system.

FIG. 13 is a block diagram illustrating the procedure embodied in the system for looking at past imports of leak data.

FIG. 14 and FIG. 15 are block diagrams illustrating the procedure initiating by “clicking” the “view leaks” button on the navigation bar.

FIG. 16 is a block diagram showing a procedure initiated by “clicking” the “reports” button on the navigation bar for producing various reports.

FIG. 17 illustrates the exit routine of the program.

FIG. 18 illustrates the general work flow of the programs shown in greater detail in FIG. 1 through FIG. 17, inclusive.

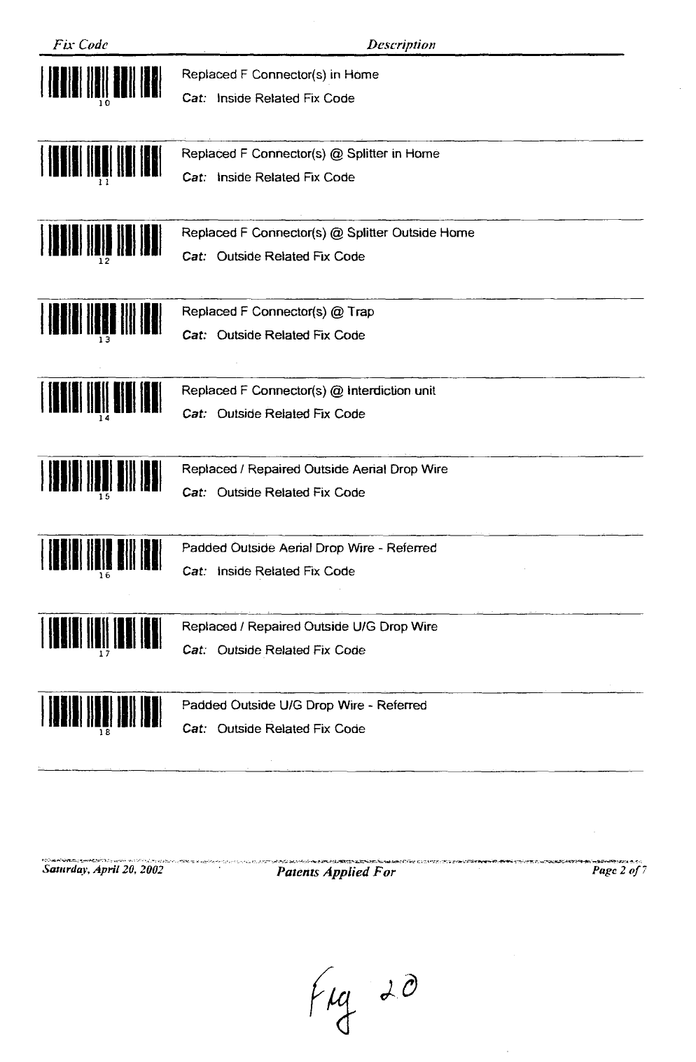

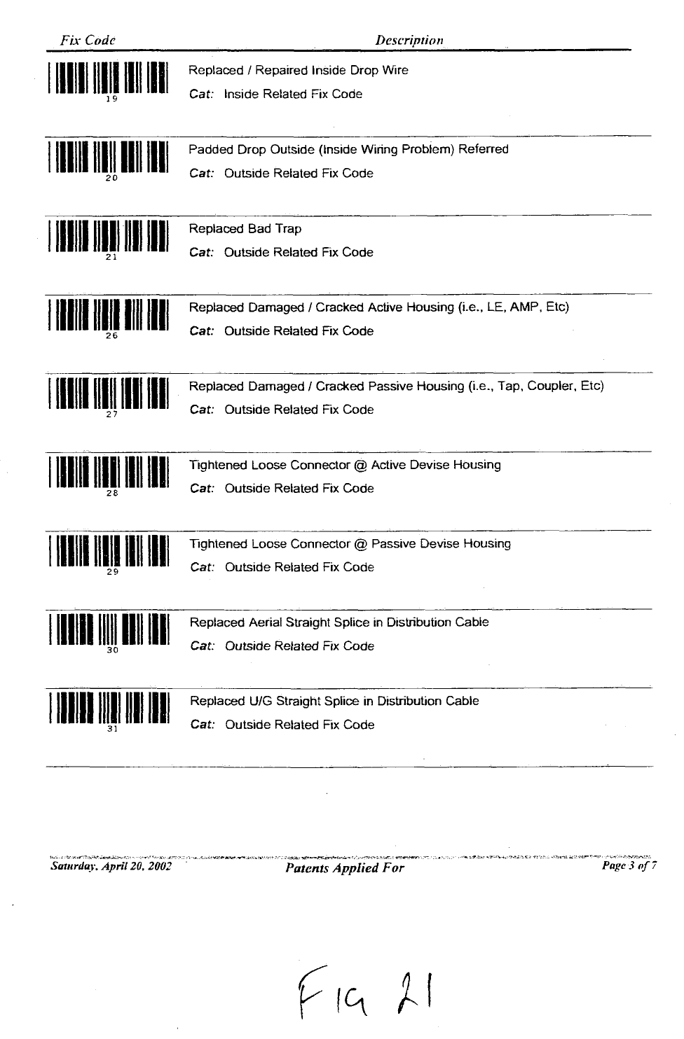

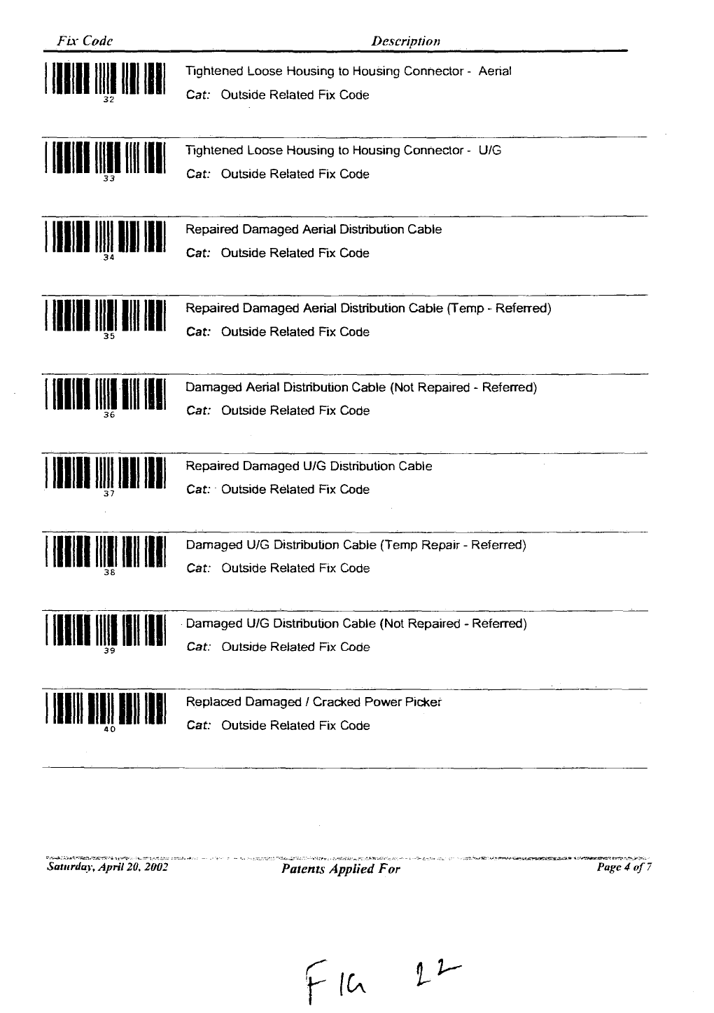

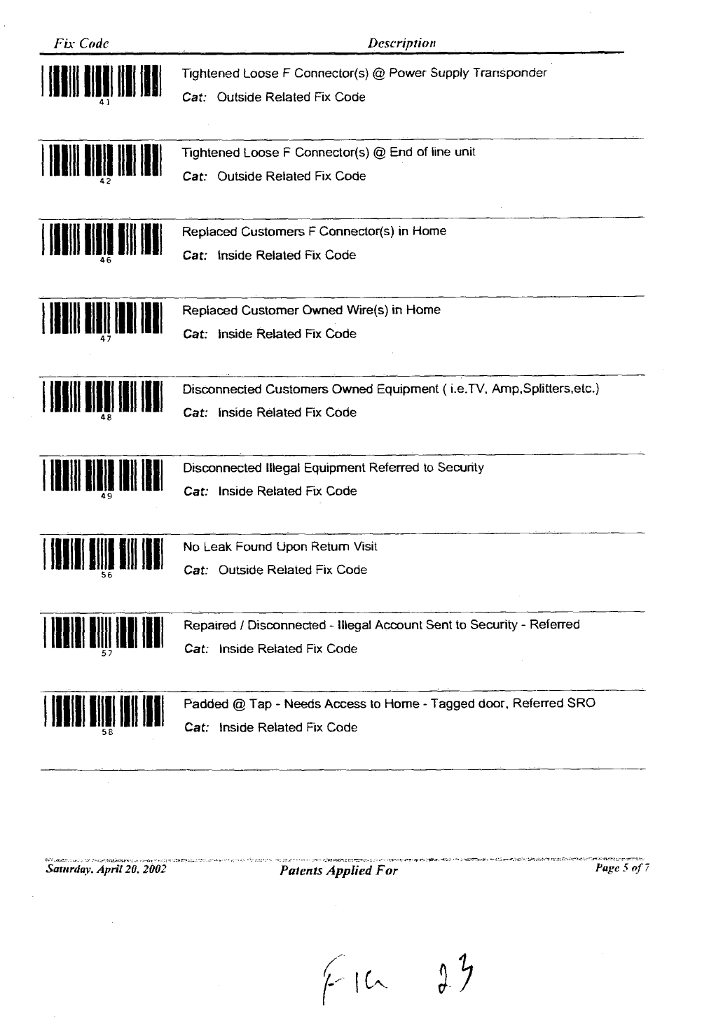

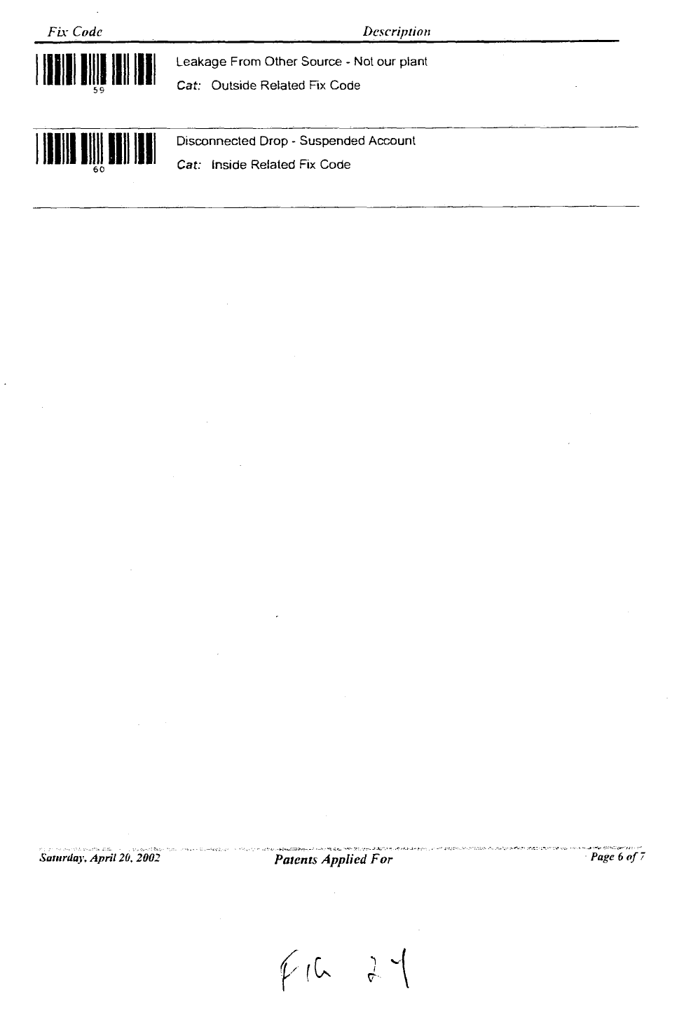

FIG. 19, FIG. 20, FIG. 21, FIG. 22, FIG. 23, FIG. 24 and FIG. 25 show illustrative “code sheets” containing information regarding frequency, test frequency, bar code format and temperature, all in bar code format.

FIG. 26 and FIG. 27 are block diagrams illustrating the flow of the software implemented in the present invention for maintaining power supplies in the field.

FIG. 26 is a flow chart illustrating the procedure for verifying power supply data, updating power supply calendar, etc.

FIG. 27 is a flow chart showing the software implemented by the present system for building bar code labels for each active device, or network component, in the system.

FIG. 28 is a block diagram illustrating a procedure for verifying test data in the field.

FIG. 29 is a block diagram illustrating a procedure for updating personnel management software.

FIG. 30 is a block diagram illustrating a procedure implemented in the system for allowing the user to obtain reports on test data.

FIG. 31 is a block diagram illustrating a procedure implemented by the system for adding a node and a power supply into the database.

FIG. 32 illustrates the software implemented by the system for compacting data and repairing data in the database.

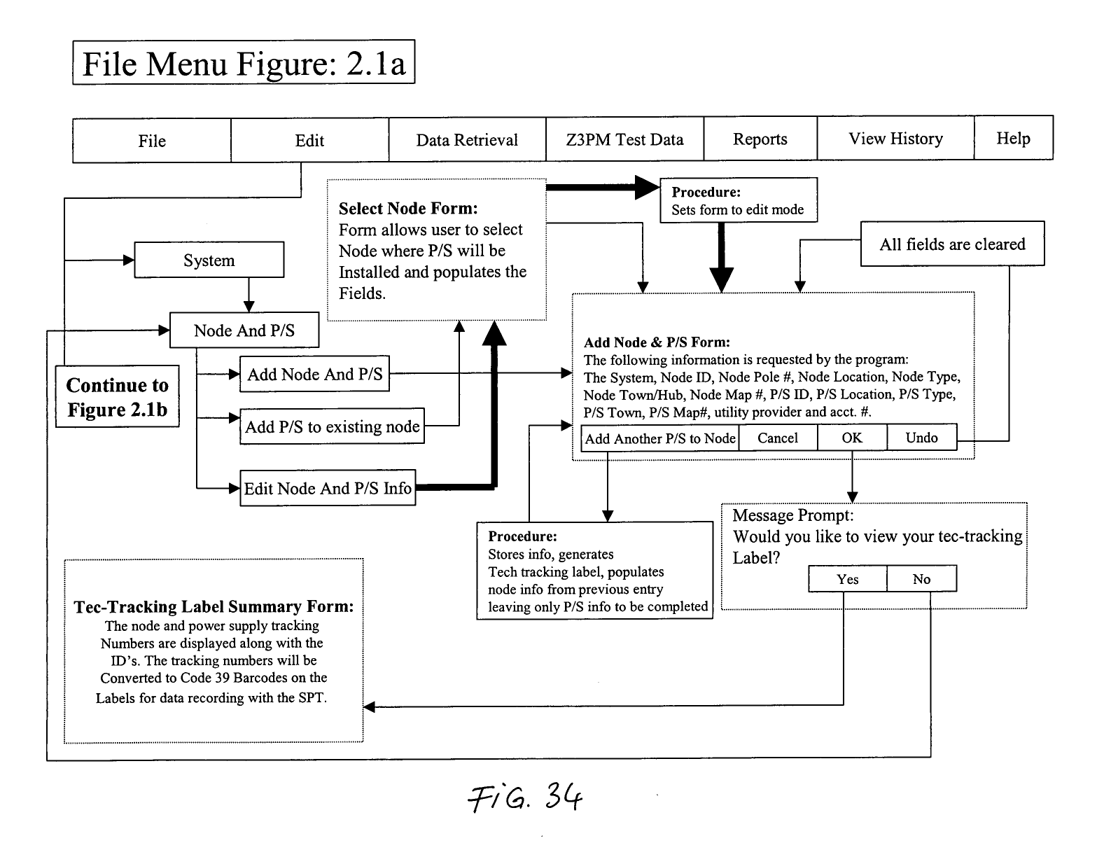

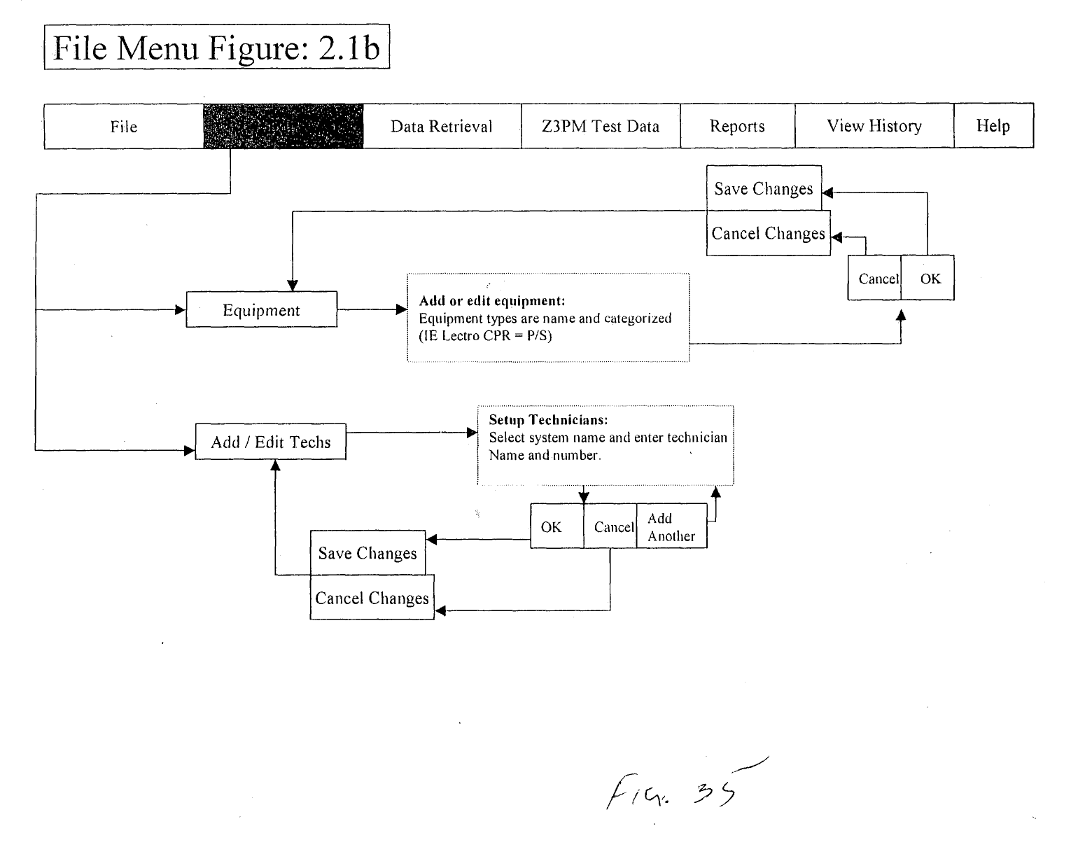

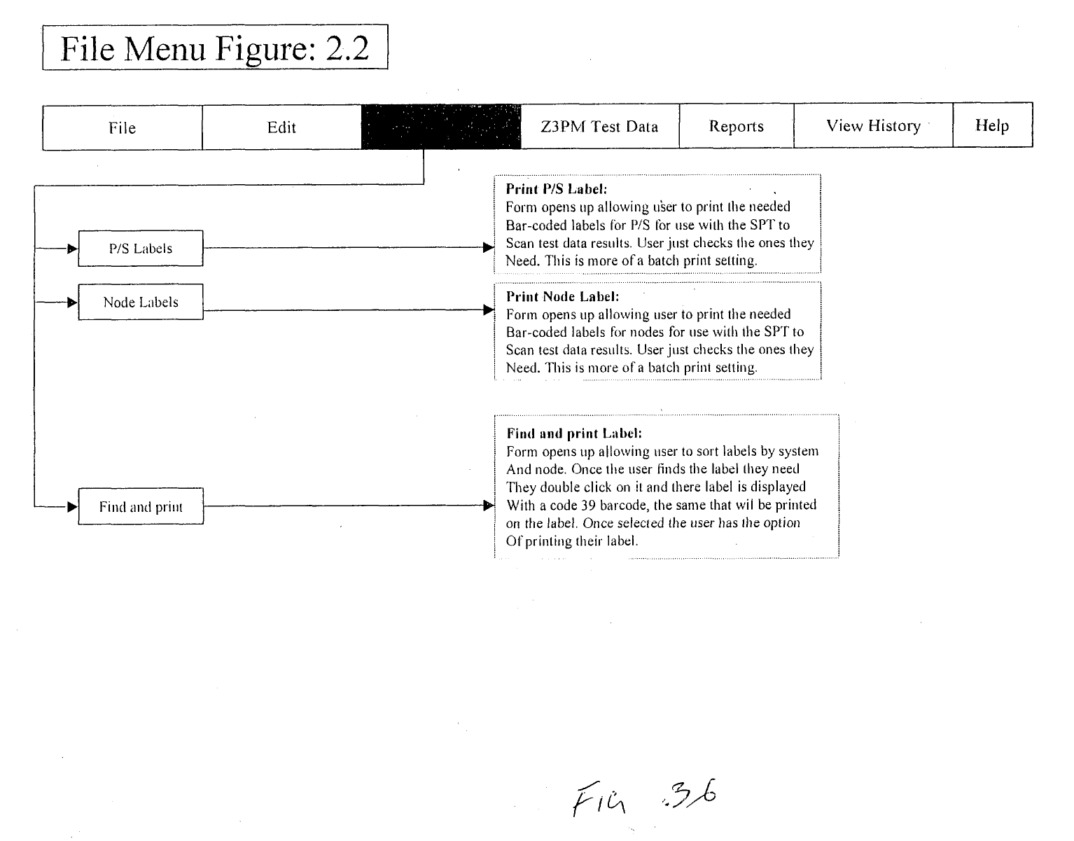

FIG. 33, FIG. 34, FIG. 35 and FIG. 36 illustrate the software implemented by the system for editing information in the database.

FIG. 37 illustrates the software implemented by the system for printing power supply labels.

FIG. 38 illustrates software implemented by the system for downloading data from the technician's hand-held device.

FIG. 39 illustrates software implemented by the system for analyzing data imported from the technician's hand-held device.

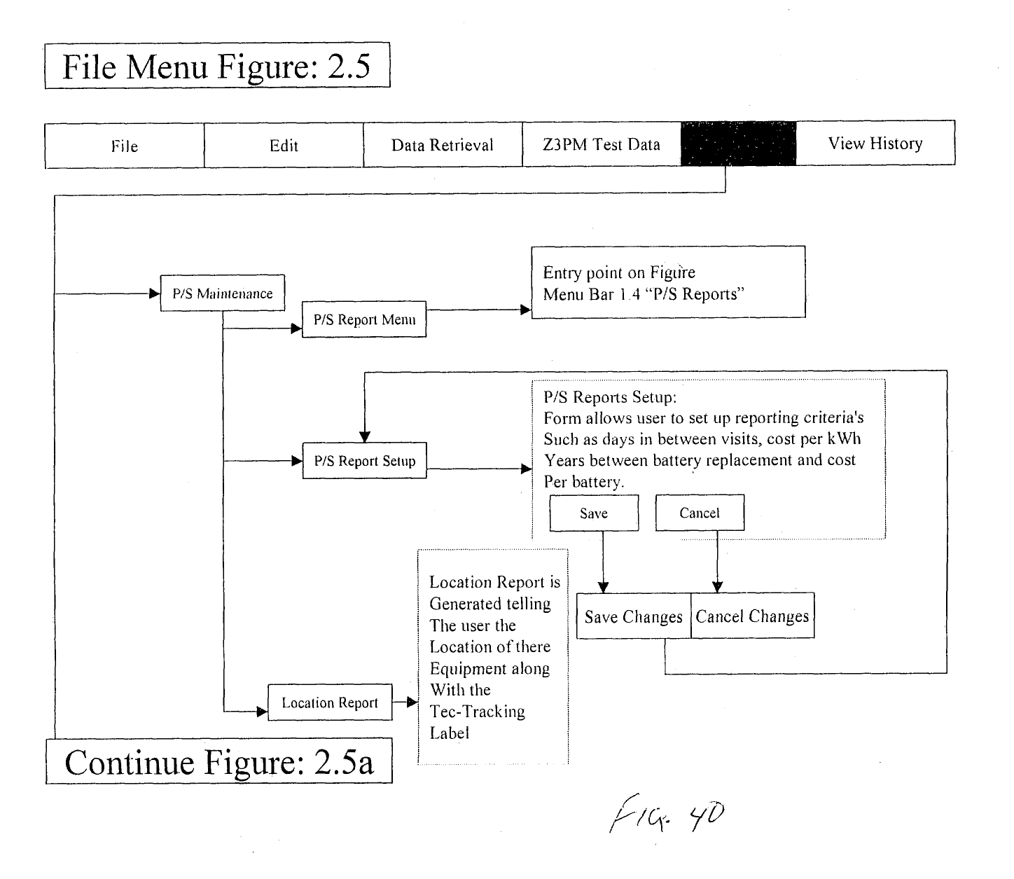

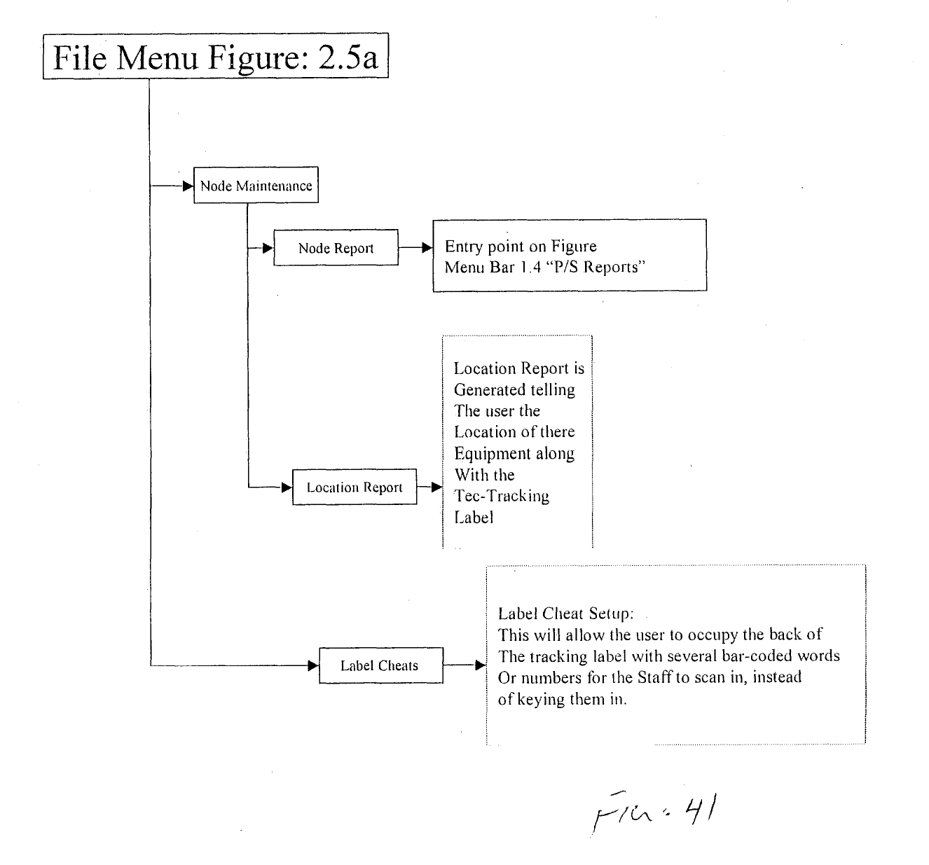

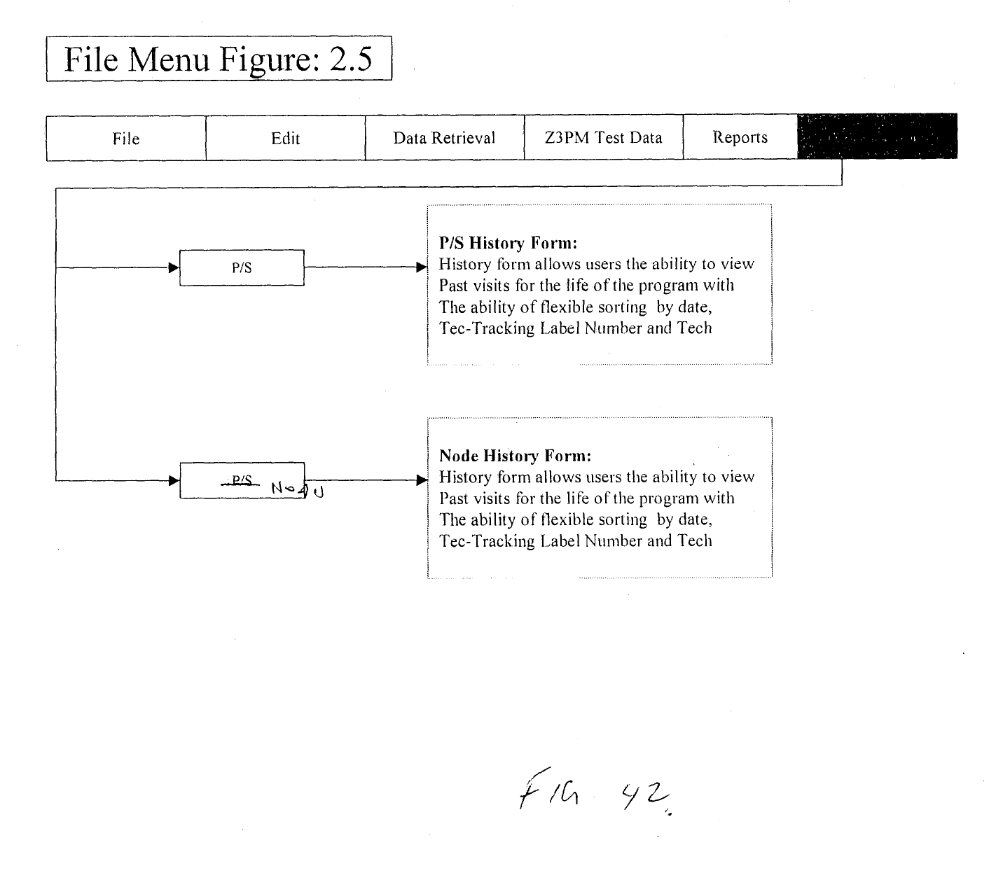

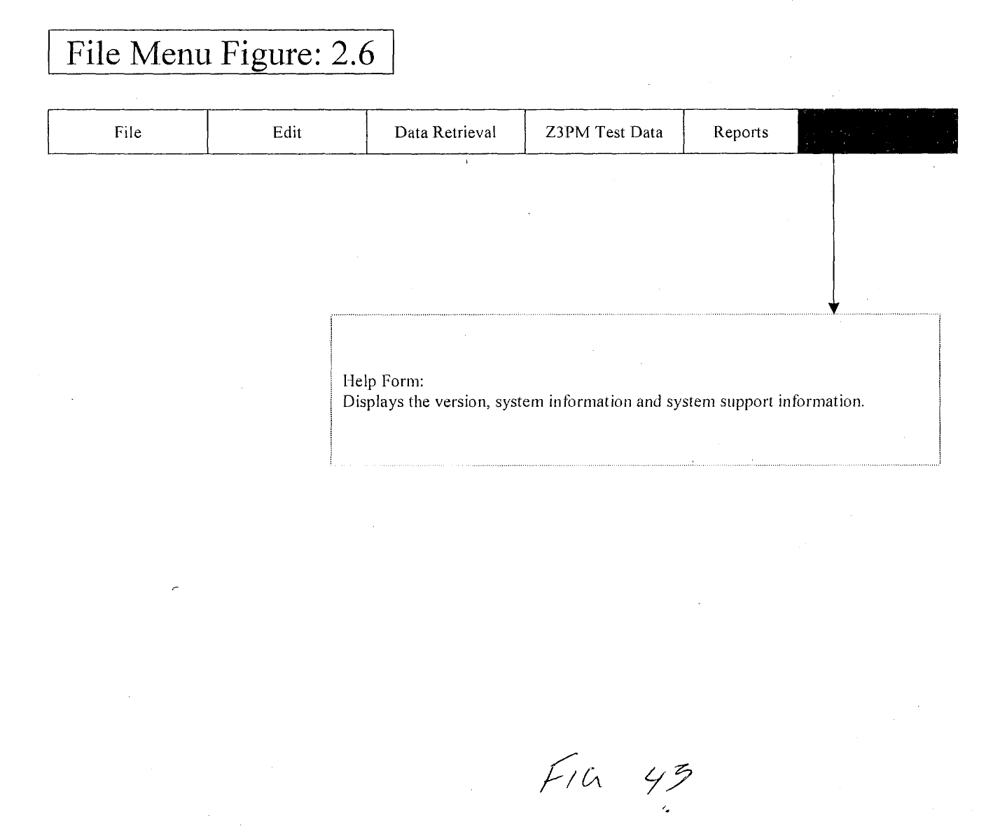

FIG. 40, FIG. 41, FIG. 42 and FIG. 43 illustrate procedures implemented by the system for verifying and analyzing data collected by hand-held devices.

FIG. 45 through FIG. 55, inclusive, illustrate in flow chart form software contained in each hand-held device for assisting the technician to service power supplies in the field.

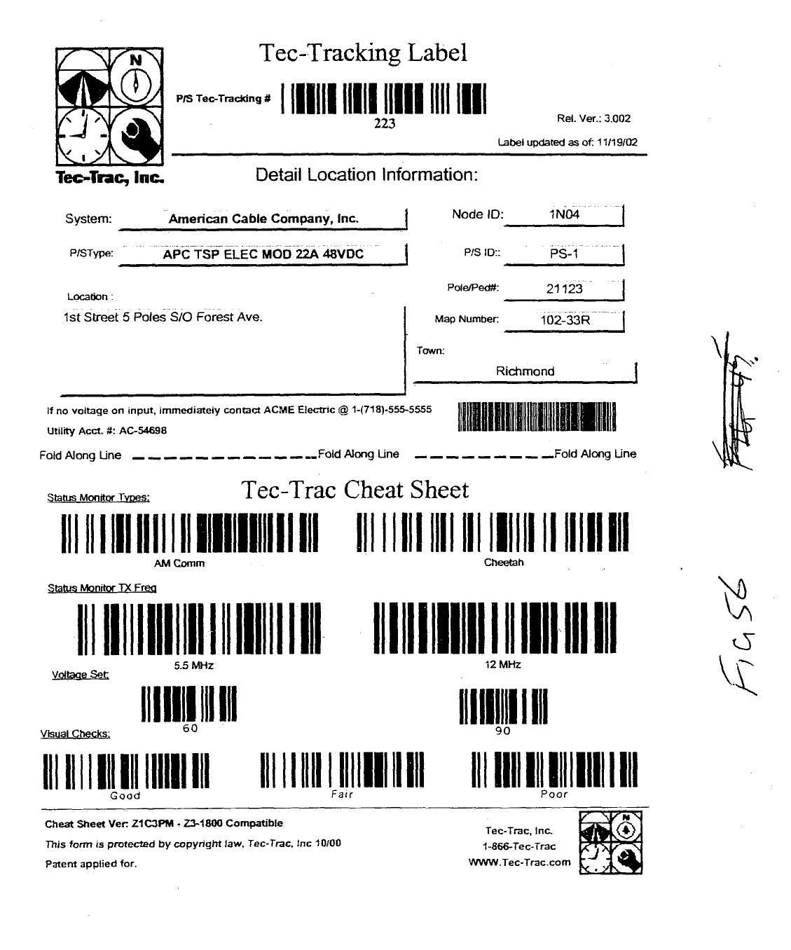

FIG. 56 illustrates a “cheat sheet” for power systems containing machine-readable data in bar code format.

FIG. 45 illustrates the overall work flow of the detailed block diagrams of FIG. 26 through FIG. 44, inclusive.

1. A system for controlling the field repair of electronic networks containing a plurality of network components disbursed geographically, said system comprising:
a) a central computer system including:
(i) memory means for storing data regarding the technical characteristics, service history and physical location of each network component; and
(ii) means for generating machine-readable records of possible repair actions for a selected one of said network components; and
b) a portable computer device, including means for reading at least a selected one of said machine-readable records.

2. The system of claim 1, wherein each said machine-readable record comprises at least one bar code.

3. The system of claim 1, wherein each said network component includes a machine-readable record uniquely identifying it.

4. The system of claim 3, wherein said portable computer device includes means for reading said uniquely identifying record.

5. The system of claim 4, wherein said portable computing device contains means for associating a uniquely identifying record with at least one repair action record.

6. The system of claim 5, wherein said system further comprises means for transferring each uniquely identifying record and the associated records from said portable computing device to said central computer system.
